(19) United States
(12) Patent Application Publication
(10) Pub. No.: US 2003/0162159 A1
(43) Pub. Date: Aug. 28, 2003

(54) Modular computer-based training system

(76) Inventor: John C. Sheehan, Dublin (IE)

Correspondence Address: MORGAN LEWIS & BOCKIUS LLP, 1111 PENNSYLVANIA AVENUE NW, WASHINGTON, DC, 20004, US

(21) Appl. No.: 10/080,935

(22) Filed: Feb. 22, 2002

(51) Int. Cl. G09B 7/00

(52) U.S. Cl. 434/362; 434/322; 434/118

(57) ABSTRACT

A computer-based methods for training a users to perform skill-based wherein a programmed computer controls the path of learning and the user controls the pace of learning, thereby enabling a novice user to gain familiarity with basic skills needed to perform the tasks. Additionally, a master mode is provided, wherein the programmed computer and user both control the path of learning, and the computer and user both control the pace of learning, thereby enabling a user having familiarity with some of the skills needed to perform the tasks. Other modes are provided as well.

### FIELD OF THE INVENTION

The present invention relates generally to the field of interactive computer-based systems and software, and more particularly to such systems, methods and software used to provide interactive computer-assisted training for client-service oriented jobs/tasks.

### BACKGROUND OF THE INVENTION

Computer-assisted training systems are known in the art. See, e.g., U.S. Pat. Nos. 6,134,539, SYSTEM, METHOD AND ARTICLE OF MANUFACTURE FOR GOAL BASED EDUCATION AND REPORTING SYSTEM; 6,208,832 B1, LEARNING SYSTEM WITH RESPONSE ANALYZER; 6,113,645, SIMULATED PLAY OF INTERACTIVE MULTIMEDIA APPLICATIONS FOR ERROR DETECTION; and 6,293,801 B1, ADAPTIVE MOTIVATION FOR COMPUTER-ASSISTED TRAINING SYSTEM; 6,292,792 B1, SYSTEM AND METHOD FOR DYNAMIC KNOWLEDGE GENERATION AND DISTRIBUTION; all incorporated by reference herein. Existing systems, however, are less than ideal.

One drawback of traditional computer-assisted training systems is the tendency to teach “book knowledge,” as opposed to “skills” that the student can immediately apply on the job. While certain programs—like flight simulators—provide a realistic environment in which necessary on-the-job skills can be practiced and mastered, typical business-oriented training systems lack the such real-time character.

Another disadvantage of traditional computer-assisted training systems involves a lack of modularity, meaning that code used to perform certain functions (e.g., display a table, calculate a value, etc.) often needs to be rewritten in order to be useful in an environment other than that for which it was written.

A still further disadvantage of traditional computer-assisted training methods is that they do not effectively integrate the advantages of both traditional knowledge teaching systems (which are most appropriate for novices) and do-or-die simulator systems (which are most appropriate for intermediate/advanced students).

The invention, as described below, addresses these and other needs.

### SUMMARY OF THE INVENTION

In light of the above, one object of the invention relates to methods, systems and articles-of-manufacture for providing an improved computer-based learning environment.

Another object of the invention relates to methods, systems and articles-of-manufacture for improving the skills-learning efficiency of computer-based training systems.

Yet another object of the invention relates to improving modularity and code reusability in a computer-based training system.

And still another object of the invention relates to methods, systems and articles-of-manufacture for providing comprehensive, real-world skills assessment in computer-based learning environments.

Accordingly, generally speaking, and without intending to be limiting, one aspect of the invention relates to computer-based method(s) for training a user(s) to perform skill-based task(s) by, for example, (i) providing a learn mode, wherein a programmed computer controls the path of learning and the user controls the pace of learning, thereby enabling a novice user to gain familiarity with basic skills needed to perform the task(s), (ii) providing a master mode, wherein the programmed computer and user both control the path of learning, and the computer and user both control the pace of learning, thereby enabling a user having familiarity with some of the skills needed to perform the task(s) to gain additional knowledge and/or confidence in applying the needed skills in performing the task(s), and (iii) providing a conquer mode, wherein the user controls the path of learning and the programmed computer controls the pace of learning, thereby enabling a user having familiarity with most of the skills needed to perform the task(s) to gain additional knowledge and/or confidence in applying the needed skills through real-time, free-flowing simulations of the task(s), wherein providing the learn, master and conquer modes involves use of multiple, replaceable software modules to provide functionality needed to support the learn, master and conquer modes. The replaceable software modules may include one, two or three of: (i) replaceable media file(s); (ii) replaceable interactive display module(s); and/or (iii) replaceable software calculator(s). And the method preferably involves use of a core Macromedia Authorware program to control loading and/or execution of the replaceable software module(s). The core Macromedia Authorware program may control a number of demand-loaded modules, such as: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and/or (xi) flash movie files used to provide animated explanations.

Again, generally speaking, and without intending to be limiting, another aspect of the invention relates to computer-based method(s) for training user(s) for financial trading desk operations by, for example, providing an interactive display that includes one, two, three, four or five of (a) a tabular display that includes, at least, price data for a plurality of financial products, (b) at least one inbound telephone line icon for receiving simulated client calls, (c) one or more outbound telephone line icons for placing simulated outbound calls, (d) at least one calculator icon for permitting user(s) to perform financial calculations, and/or (e) a help icon for providing hints and/or explanations to user(s) by, for example, selectively loading and executing replaceable software modules, including at least one, two, or three of (i) replaceable media file(s), (ii) replaceable interactive display module(s), and/or (iii) replaceable software calculator(s).

Again, generally speaking, and without intending to be limiting, another aspect of the invention relates to computer-based method(s) for training user(s) for financial trading desk operations by, for example, providing an interactive display that includes one, two, three, four, or five of (i) a tabular display that includes, at least, price data for a plurality of financial products, (ii) at least one inbound telephone line icon for receiving simulated client calls, (iii) one or more outbound telephone line icons for placing simulated outbound calls, (iv) at least one calculator icon for permitting user(s) to perform financial calculations, and/or (v) a help icon for providing hints and/or explanations to user(s) by, for example, selectively loading and/or executing a number of replaceable software modules, including, for example, (i) replaceable media file(s), (ii) replaceable interactive display module(s), and/or (iii) replaceable software calculator(s).

Again, generally speaking, and without intending to be limiting, another aspect of the invention relates to method(s) for training student(s) for financial trading occupations by, for example, using a programmed computer workstation to guide the student(s) through a multiphase learning process by, for example, providing a computer-driven learn mode in which novice student(s) can gain familiarity with basic financial trading concepts and/or skills, providing a computer-driven master mode in which student(s) begin to test the skills acquired in the learn mode by engaging in guided scenario simulations that require student(s) to effectively apply selected skill(s), and providing a conquer mode in which student(s) refine and test their mastery of learned skill(s) by, for example, engaging in realistic, free-flowing simulations and test their ability to meet predetermined objective(s) by reviewing detailed post-simulation performance reports, including, for example, one or more of (a) a detailed report of the student's trading positions throughout the simulation, (b) a detailed report of the student's ability to remain within trading limits during the simulation, (c) a detailed report of risk(s) associated with the student's trading activity during the simulation, (d) a detailed report of the student's trading activity during the simulation, including at least the number of calls serviced and the number winning/losing trades, (e) a detailed report of the accuracy of price quotes given by the student during the simulation, (f) a detailed report of the timeliness of the student's responses during the simulation, (g) a detailed analysis the student's willingness to anticipate trades during the simulation, and/or (h) a summary report of the student's overall performance during the simulation. At least the conquer mode is preferably provided by selectively loading and executing replaceable software module(s), including, for example, one or more of: (i) replaceable media file(s); (ii) replaceable interactive display module(s); and/or (iii) replaceable software calculator(s).

Again, generally speaking, and without intending to be limiting, another aspect of the invention relates to computer-based system(s) for training a user to perform skill-based task(s) that include, for example, a programmed computer having (a) a learn mode engine which controls the user's path of learning and permits the user to control the pace of learning, thereby enabling a novice user to learn basic skills needed to perform the task(s), (b) a master mode engine which controls in part, and permits the user to control in part, both the path of learning and the pace of learning, thereby enabling a user having familiarity with some of the skills needed to perform the task(s) to gain additional knowledge and/or confidence in applying the needed skills in performing the task(s), and/or (c) a conquer mode engine which controls the pace of learning, and permits the user to control the path of learning, thereby enabling a user having familiarity with most of the skills needed to perform the task(s) to gain additional knowledge and/or confidence in applying the needed skills through real-time, free-flowing simulations of the task(s), wherein at least one of the learn mode engine, master mode engine and/or conquer mode engine includes a number of replaceable software modules. The replaceable software modules may include one or more of: (i) replaceable media file(s); (ii) replaceable interactive display module(s); and/or (iii) replaceable software calculator(s). The system preferably also includes a core Macromedia Authorware program, which controls loading and/or execution of the replaceable software modules. The modules loaded by the core Macromedia Authorware program may include: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and/or (xi) flash movie files used to provide animated explanations.

Again, generally speaking, and without intending to be limiting, another aspect of the invention relates to computer-based system(s) for training user(s) for financial trading desk operations, which system(s) may include, for example, an interactive display that includes at least two, three, four or more of (a) a tabular display that includes, at least, price data for a plurality of financial products, (b) at least one inbound telephone line icon for receiving simulated client calls, (c) one or more outbound telephone line icons for placing simulated outbound calls, (d) at least one calculator icon for permitting user(s) to perform financial calculations, and/or (e) a help icon for providing hints and/or explanations to user(s), and may further include, for example, a core Macromedia Authorware program that controls loading and/or execution of a plurality of replaceable software modules, such as (i) replaceable media file(s), (ii) replaceable interactive display module(s), and/or (iii) replaceable software calculator(s).

Again, generally speaking, and without intending to be limiting, another aspect of the invention relates to system(s) for training student(s) for financial trading occupations, which system(s) may include, for example, a computer workstation programmed to guide the student(s) through a multiphase learning process, including (a) a learn mode, in which novice student(s) can gain familiarity with basic financial trading concepts and/or skills, (b) a master mode, in which student(s) begin to test the skills acquired in the learn mode by engaging in guided scenario simulations that require student(s) to effectively apply selected skill(s), and (c) a conquer mode, in which student(s) refine and test their mastery of learned skill(s) by engaging in realistic, free-flowing simulations and test their ability to meet predetermined objective(s) by reviewing detailed post-simulation performance reports, such as (i) a detailed report of the student's trading positions throughout the simulation, (ii) a detailed report of the student's ability to remain within trading limits during the simulation, (iii) a detailed report of risk(s) associated with the student's trading activity during the simulation, (iv) a detailed report of the student's trading activity during the simulation, including at least the number of calls serviced and the number winning/losing trades, (v) a detailed report of the accuracy of price quotes given by the student during the simulation, (vi) a detailed report of the timeliness of the student's responses during the simulation, (vii) a detailed analysis the student's willingness to anticipate trades during the simulation, and/or (viii) a summary report of the student's overall performance during the simulation, and may further include, for example, code which, in at least the conquer mode, controls loading and/or execution of replaceable software module(s), such as (i) replaceable media file(s), (ii) replaceable interactive display module(s), and/or (iii) replaceable software calculator(s).

Again, generally speaking, and without intending to be limiting, another aspect of the invention relates to computer-readable media for use in connection with computer-based training system(s), such computer-readable media including, for example, instructions which, when executed, cause a computer to provide at least two distinct modes of computer-based learning functionality, the computer-readable media further including a number of demand-loaded modules, such as (i) a simulation control module that provides the logic flow for running interactive task simulations, (ii) a question-and-answer module that permits database-driven testing of user(s), (iii) a table module that permits interactive display, scrolling and highlighting of tables, (iv) an explanation zone module that provides database-driven and tracked web-page browsing of explanations, (v) a calculator module that permits user(s) to perform complex calculations, (vi) a download module that manages downloading of files for use by the programmed computer and uploading of user-tracking data to a central database, (vii) sound files used to generate speech, (viii) table files used to provide text for display in tables, (ix) graphics files used to generate pictures, (x) web pages used to provide explanations, and/or (xi) flash movie files used to provide animated explanations.

Additional aspects of the invention relate to systems, structures and articles-of-manufacture used, or useful, in connection with all, or part, of the above-described methods.

Still further aspects of the invention relate to different combinations or sub-combinations of the above-described elements and process steps, and/or combinations or sub-combinations of the above-described elements and/or process steps with elements and/or process steps described in the incorporated patent(s).

### BRIEF DESCRIPTION OF THE DRAWINGS

Various aspects, features and advantages of the instant invention are depicted in the accompanying set figures, which is intended to be illustrative, rather than limiting, and in which:

FIG. 1 depicts computer vs. user control of the learning path and learning pace in accordance with an illustrative embodiment of the invention;

FIG. 2 depicts a database content entry form for use in connection with an illustrative embodiment of the invention;

FIG. 3 depicts a flow chart of selected “learn mode” functionality in accordance with an illustrative embodiment of the invention;

FIG. 4 depicts a flow chart multiple, interspersed conversations in accordance with an illustrative embodiment of the invention;

FIG. 5 depicts the high-level software architecture of an illustrative embodiment of the invention;

FIG. 6 depicts an exemplary “learn mode” screen shot from an illustrative embodiment of the invention;

FIG. 7 depicts another exemplary “learn mode” screen shot from an illustrative embodiment of the invention;

FIG. 8 depicts yet another exemplary “learn mode” screen shot from an illustrative embodiment of the invention;

FIG. 9 depicts still another exemplary “learn mode” screen shot from an illustrative embodiment of the invention;

FIG. 10 depicts an exemplary screen shot produced by a replaceable software module used in an illustrative embodiment of the invention;

FIG. 11 depicts another exemplary screen shot produced by a replaceable software module used in an illustrative embodiment of the invention;

FIG. 12 depicts yet another exemplary screen shot produced by a replaceable software module used in an illustrative embodiment of the invention;

FIG. 13 depicts still another exemplary screen shot produced by a replaceable software module used in an illustrative embodiment of the invention;

FIG. 14 depicts an exemplary “master mode” screen shot from an illustrative embodiment of the invention;

FIG. 15 depicts another exemplary “master mode” screen shot from an illustrative embodiment of the invention;

FIG. 16 depicts yet another exemplary “master mode” screen shot from an illustrative embodiment of the invention;

FIG. 17 depicts still another exemplary “master mode” screen shot from an illustrative embodiment of the invention;

FIG. 18 depicts yet another exemplary “master mode” screen shot from an illustrative embodiment of the invention;

FIG. 19 depicts an exemplary “conquer mode” screen shot from an illustrative embodiment of the invention;

FIG. 20 depicts another exemplary “conquer mode” screen shot from an illustrative embodiment of the invention;

FIG. 21 depicts yet another exemplary “conquer model” screen shot from an illustrative embodiment of the invention;

FIG. 22 depicts still another exemplary “conquer mode” screen shot from an illustrative embodiment of the invention;

FIG. 23 depicts yet another exemplary “conquer model” screen shot from an illustrative embodiment of the invention;

FIG. 24 depicts still another exemplary “conquer mode” screen shot from an illustrative embodiment of the invention;

FIG. 25 depicts yet another exemplary “conquer mode” screen shot from an illustrative embodiment of the invention;

FIG. 26 depicts still another exemplary “conquer mode” screen shot from an illustrative embodiment of the invention;

FIGS. 27A-H collectively depict an exemplary replaceable code module used to determine the positions of traders for a “conquer mode” simulation in an illustrative embodiment of the invention;

FIGS. 28A-G collectively depict an exemplary replaceable code module used to create an incoming call for a “conquer model” simulation in an illustrative embodiment of the invention;

FIGS. 29A-FF collectively depict an exemplary replaceable code module used to record a deal for a “conquer model” simulation in an illustrative embodiment of the invention; and,

FIGS. 30A-Z collectively depict an exemplary replaceable code module used to calculate trades for a “conquer model” simulation in an illustrative embodiment of the invention.

### DESCRIPTION OF ILLUSTRATIVE EMBODIMENT(S)

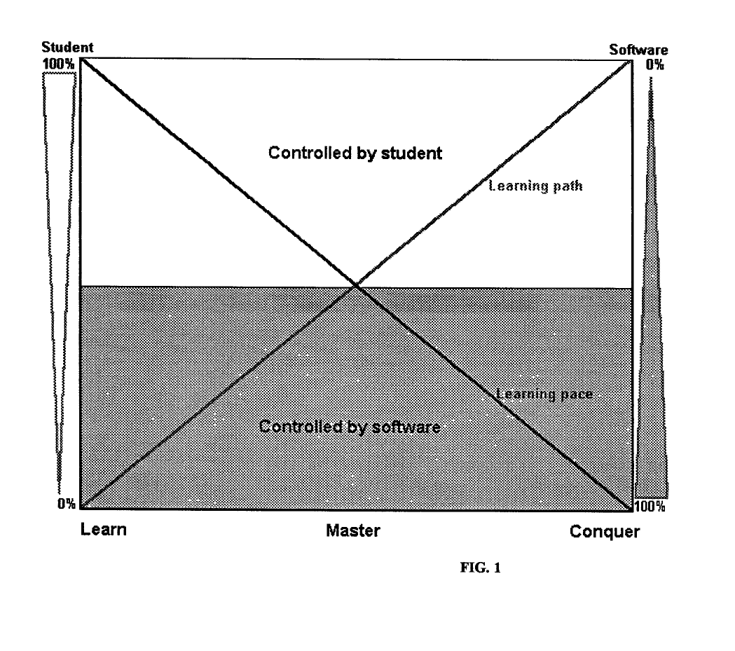

Reference is initially made to FIG. 1, which depicts computer vs. user control of the learning path and learning pace in accordance with an illustrative embodiment of the invention. Whereas conventional approaches teach knowledge alone, simulators according to the invention teach skills and knowledge. To do this, the invention preferably replicates the workplace in virtual reality. Instead of telling or asking students how to deal with a specific situation, it places them in that situation and helps them to deal with it. Simulators according to the invention preferably have three zones, as follows:

1. The Dealing Zone teaches skills and reinforces knowledge through real-time simulation and interaction. Real-time learning by doing provides an effective cognitive apprenticeship that provides powerful-guided discovery.

2. The Explanation Zone provides the knowledge to support the skills with reference material and explanations of concepts. It caters for differing learning styles by providing text-based training for the reader in the form of text or audio-visual training in the form of animations with narration for those who prefer to listen and watch.

3. The Question and Answer Zone provides self-assessment, feedback and reinforcement through conventional testing.

The invention provides a learning approach is based on three very important learning principles:

1. The cognitive apprenticeship approach (i.e., the “skill based approach”) is the one that works. This is “learning by doing.”

2. Technology should never hinder, only help the learning process. It should replicate the real environment.

3. There should be a crossover between control of the “learning paths” and the “pace” as the user climbs the learning curve.

Initially, technology controls the learning “path” and the user controls the learning pace. However, as the learning curve is climbed, he/she gains control of “how to learn” while the technology takes over the “speed of learning.”

The invention provides a number of modes to reflect this approach: “Learn”, “Master” and “Conquer”. As students' skill and knowledge increase, the level of support gradually reduces to build their confidence and self-reliance.

At the “Learn” level, students are novices with limited understanding. The goal is to provide familiarity with the concepts and language together with an overview of the strategies used. The software controls the learning path; the student controls the learning pace.

Students using the “Learn” model find highly structured scenarios and are offered large amounts of coaching and support, as follows:

1. From a narrator who provides feedback on wrong answers and who is available to provide hints on demand.

2. From a coach who provides useful tips and advice at key points in each scenario.

3. From the software that provides the correct answers and clear explanations where students are clearly in difficulty.

4. From linkage of every stage of the simulations to relevant explanations in the Explanation Zone.

At the “Master” level, students are becoming more confident and knowledgeable. They receive some guidance but are given more freedom to experiment. The control of learning path and learning pace begins to cross over between the software and the student.

The simulations reflect this, as the scenarios become more challenging and students are tracked more rigorously. Rather than merely responding to the situation, students are given objectives that they must try to achieve before they start each simulation. While still receiving support, students begin to see the consequences of mistakes, and are pushed to apply the skills and knowledge they started to build during the “Learn” mode.

By the time students reach “Conquer” they will have an understanding of most key elements. The emphasis now moves on to the effective application and development of skills. The learning path is now firmly in the hands of the student; the learning pace is controlled by the software and the simulations within it.

The simulations at this level are free flowing and realistic—e.g., running the same simulation twice will not result in the same order or number of transactions. Based on the detailed feedback and performance analysis, students can choose which part of their skills to develop or work on and can judge their progress and the consequences of their actions for themselves.

In accordance with the invention, the learning philosophy and ease of use for production take precedence over the technology used in every case. Software is used to support the philosophy and not the other way around. One challenge is to allow for cost-effective production without compromising the quality of the experience. However, simulations that work well on paper may not work well in the finished software. Moreover, all simulators are media intensive so there can be little allowance for rework and adjustment once production starts.

The invention preferably utilizes database driven reusable software kernels that contain the core functionality to manage simulations, etc. Replaceable software modules provide the required flexibility. So the amount of new coding for each application is minimized.

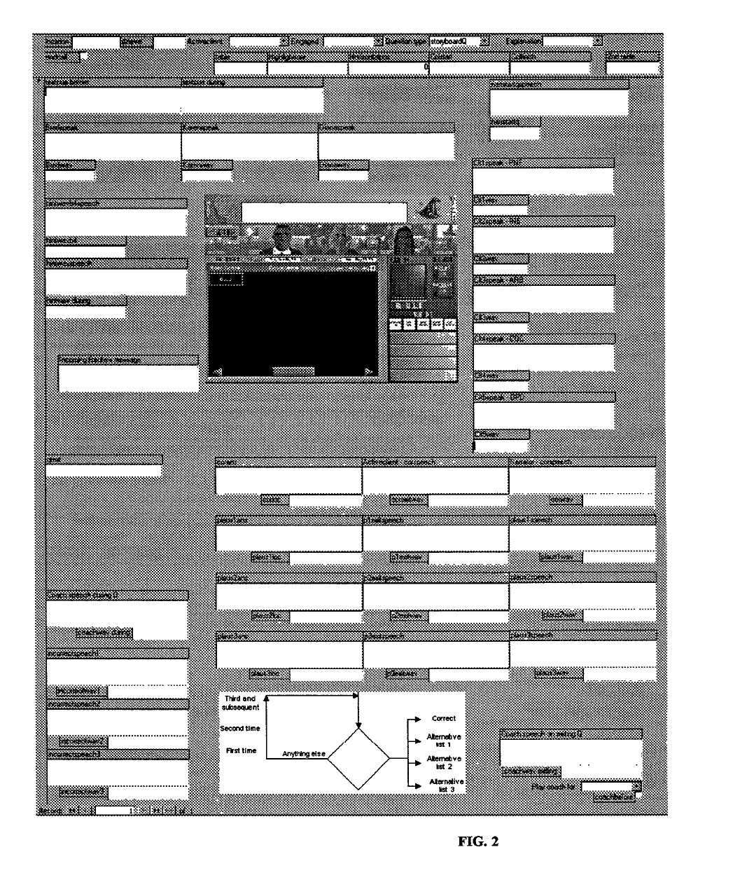

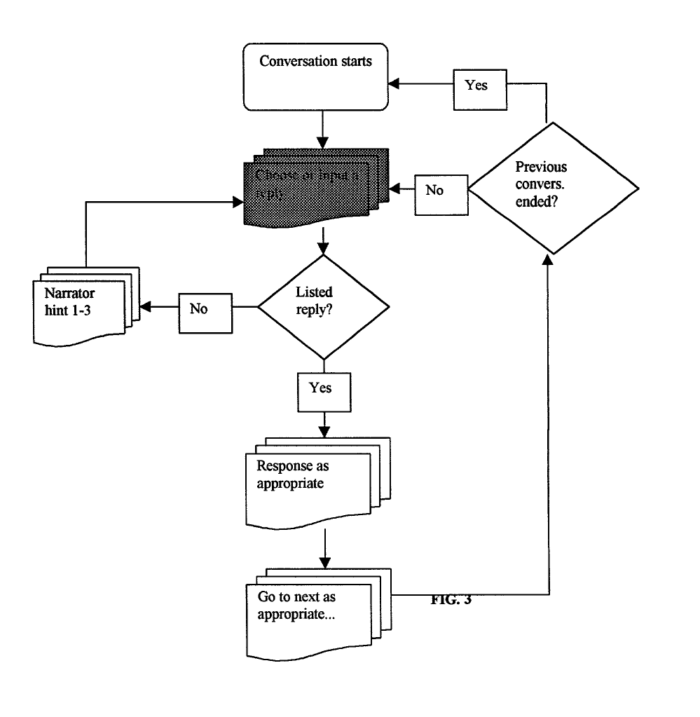

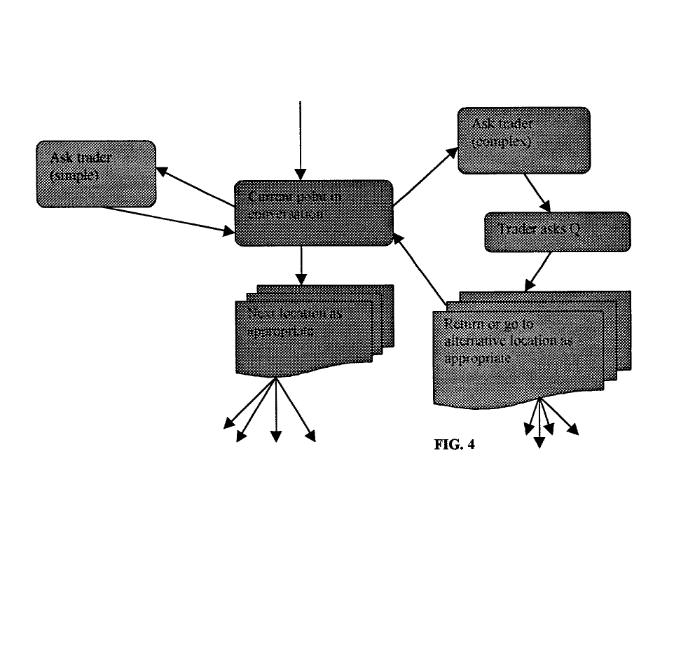

This standardized approach enhances productivity, as it allows scriptwriters to use simple database forms (e.g., FIG. 2) to produce content directly within the simulator itself, rather than waiting to review a software developer's interpretation of it. Using text-to-speech agents, entire simulations are written to completion before any costly media development is required. Scriptwriters can then preview and adjust all simulations using modified simulator software to see exactly how they would run in real life.

Referring now to FIG. 3, realistic simulation of conversation is created through a database and simple logic flow. Currently, there are up to four sets of answers at each stage of the conversation, with each able to store several possible answers as a list. With each set of answers potentially directing the student to a different conversation path, complex and realistic conversation flows may be created easily.

Referring now to FIG. 4, multiple simultaneous conversations further enhance the possibilities of the fundamental conversation flow above. Each stage in the conversation can have multiple levels—for example, to allow the student to consult a trader while talking to a client.

The same method can also be used to create conversations where the student must contact and talk to some or all of the other clients before progressing. Multiple strands of conversation can therefore be kept alive by expanding a very simple conversation logic in this way.

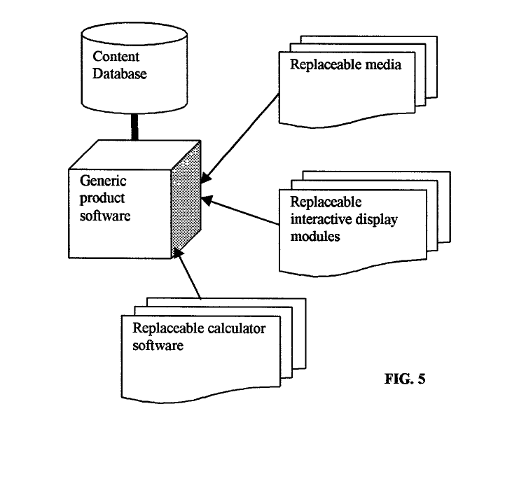

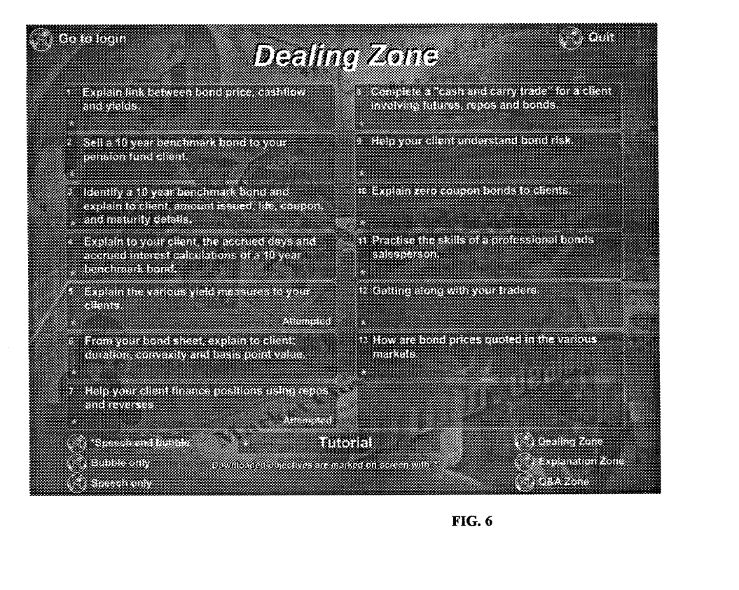

Referring now to FIG. 5, the invention provides a simple, modular architecture where core functionality is extended by the use of replaceable elements in addition to the media. Replaceable interactive display modules represent a major innovation as conventional, low-cost development technologies are used to provide very high-levels of product flexibility. The modules are not mere graphics, but interactive software that allows, for example, capital markets data to be displayed, explored and highlighted at the control of the core software. They can include buttons, dynamic data and other features to provide interactivity and functionality as needed.

Macromedia Authorware is a widely used authoring tool that provides a simple platform that will run on most current operating systems. It is used for providing the invention's core functionality, such as scheduling, database interactions and logic flow. However, Authorware is very rigid in terms of display and would require separate software for each simulator to allow functional interactive display elements to be changed. Similarly, Authorware has limited ability to handle the complex calculations required for complex (e.g., capital markets) training environments.

Replaceable interactive display modules are preferably written in Macromedia Flash, a widely used web animation technology that uses vector-based graphics to provide animation and visually stunning graphics. Using Flash, templates are provided for a number of interactive display elements, such as scrolling tables that can be highlighted on demand. The core Authorware software loads these templates on demand, provides them with display data, and controls their behavior.

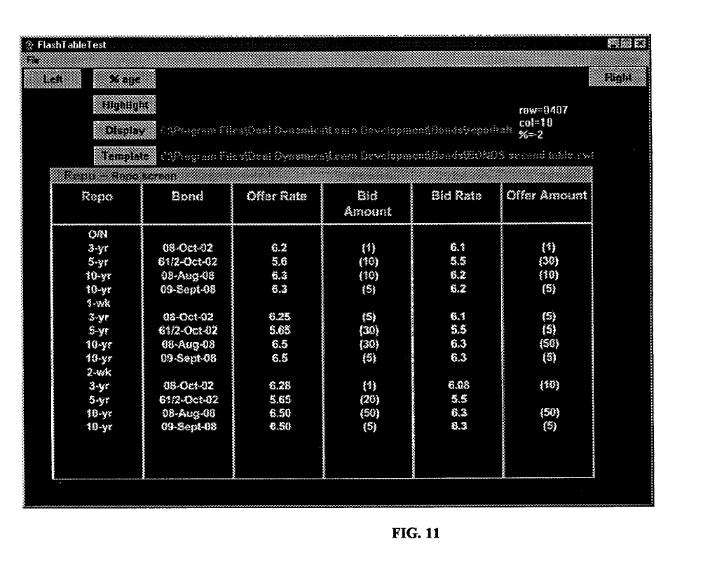

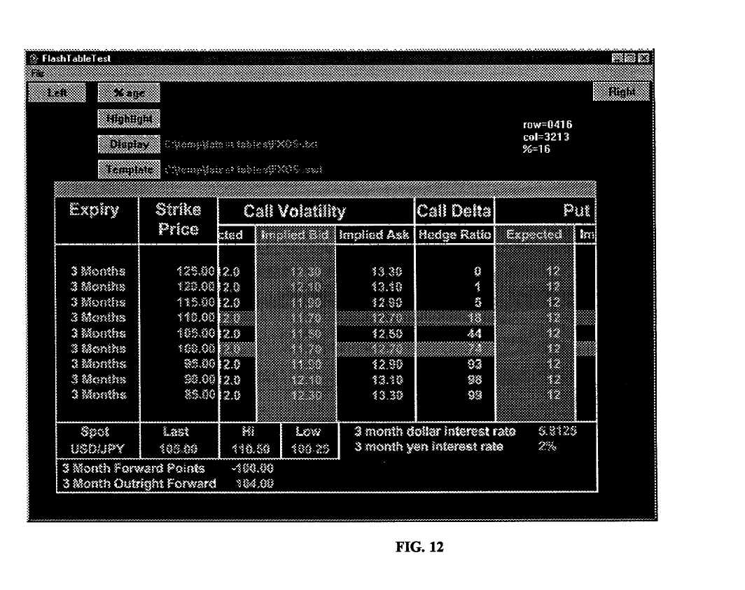

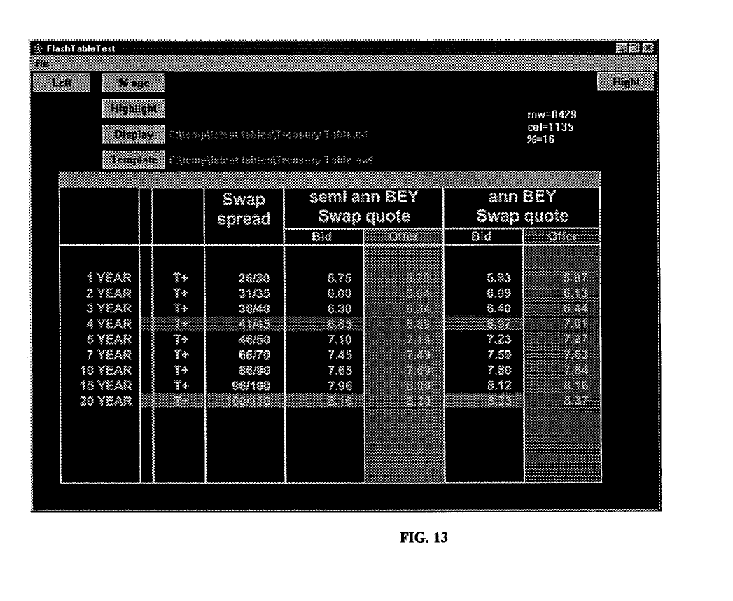

The use of Flash in this way provides the invention with a powerful and flexible means to incorporate a wide range of interactive and display features on demand without affecting the underlying core functionality of the Authorware software. Examples of such replaceable display modules appear in FIG. 10 (bonds scrolling table module), FIG. 11 (bonds CTD sheet module), FIG. 12 (FX options table module) and FIG. 13 (IRS LIBOR table module).

To provide unlimited flexibility, each objective in each simulator has up to two independent software applications specified in the database that can be launched on demand. Currently, the calculators are written using visual basic.

Modular components of the presently preferred embodiment are listed below.

| Component | Type | Description |
|---|---|---|
| Launchpad | Software | Authorware software that maintains database connection, |
| | | provides product navigation and controls download software. |
| Dealing Zone | Software | Authorware software that provides the logic flow for |
| | | simulations. Loaded by Launchpad. |
| Q&A Zone | Software | Authorware software that provides database driven and |
| | | tracked testing of students. Loaded by Launchpad. |
| Flash table | Software/Media | Interactive display modules loaded on demand into the |
| modules | | Dealing Zone and Q&A Zone. |
| Explanation Zone | Software | Authorware software that provides database driven and |
| | | tracked web-page browsing of explanations. Loaded by |
| | | Launchpad. |
| Calculator | Software | Custom executables that provide complex calculations for |
| software | | students. |
| Download | Software | Custom executable that manages downloading of files as |
| software | | requested by Launchpad and uploading of student-tracking |
| | | data to a central database. |
| Sound files | Media | Compressed voice recordings used for Dealing Zone |
| Table files | Media | Text information for display in table modules |
| Graphics | Media | Pictures for use in Dealing Zone and Question & Answer |
| | | Zone |
| Web pages | Media | Conventional HTML web pages for Explanation Zone |
| Flash movies | Media | Animated and narrated explanations for use in the Explanation |
| | | Zone |

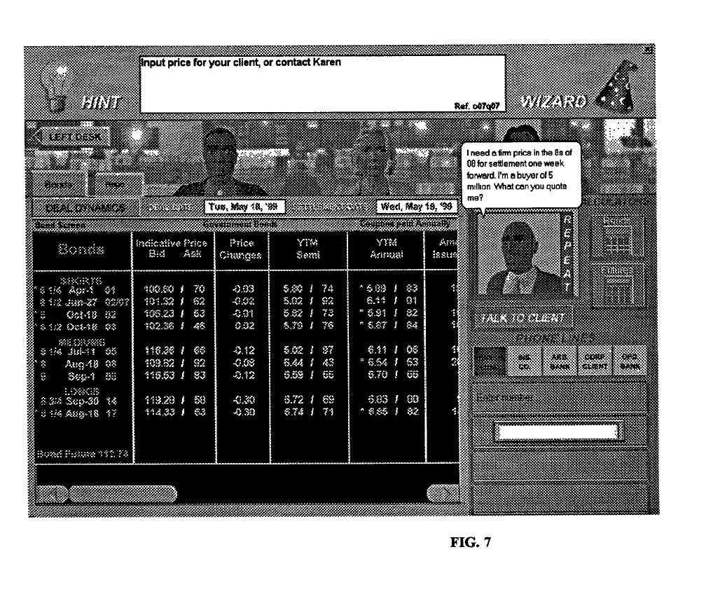

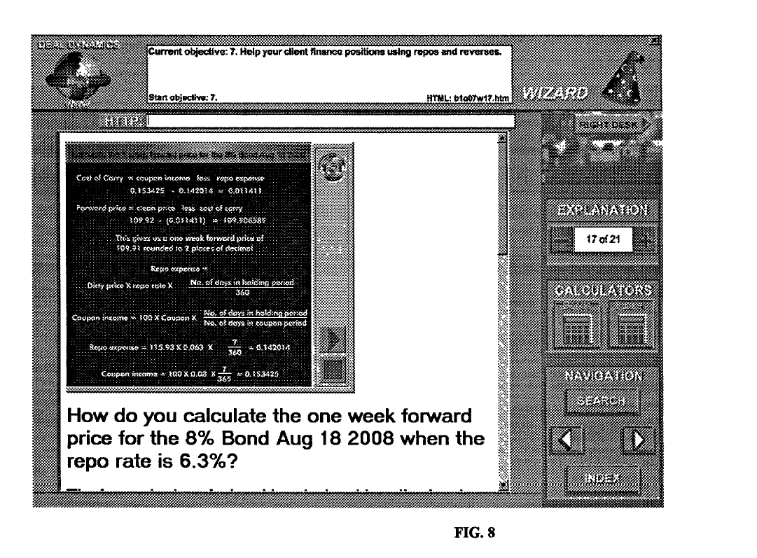

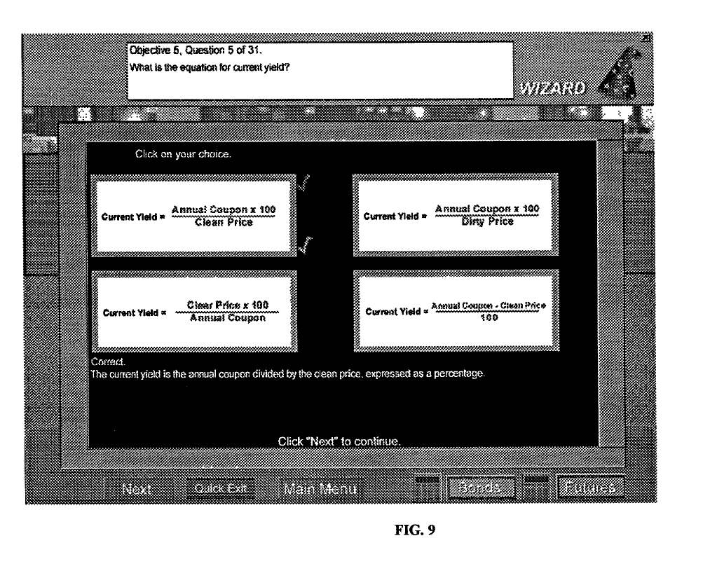

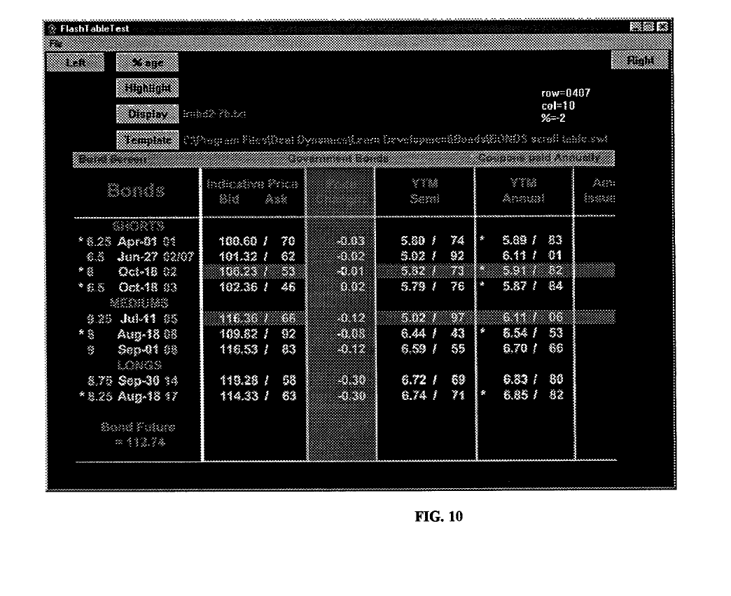

An illustrative embodiment of the invention provides computer-assisted training in the operation of a capital markets trading desk. FIGS. 6-9 depict learn mode functionality for the illustrative embodiment. In particular, FIG. 6 exemplifies objective selection for a “learn bonds” module. FIG. 7 displays a typical dealing zone view from “learn bonds.” FIG. 8 displays a typical explanation zone view from “learn bonds.” And FIG. 9 displays a typical question and answer zone view from “learn bonds.”

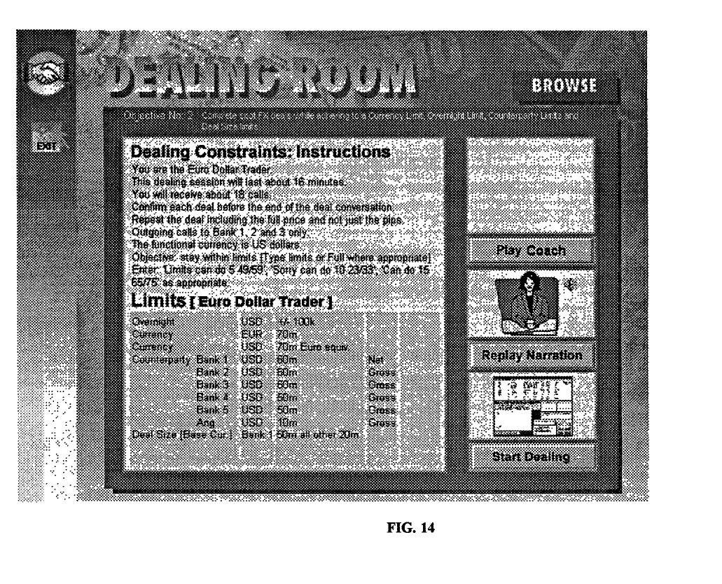

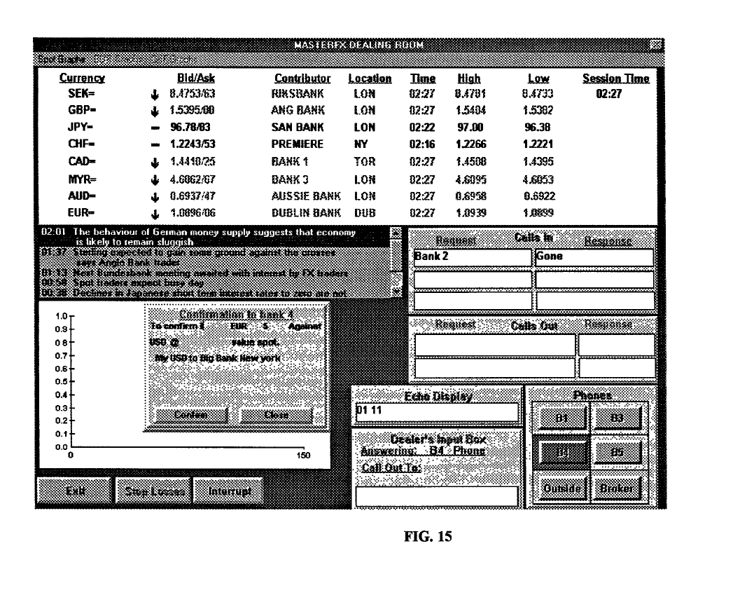

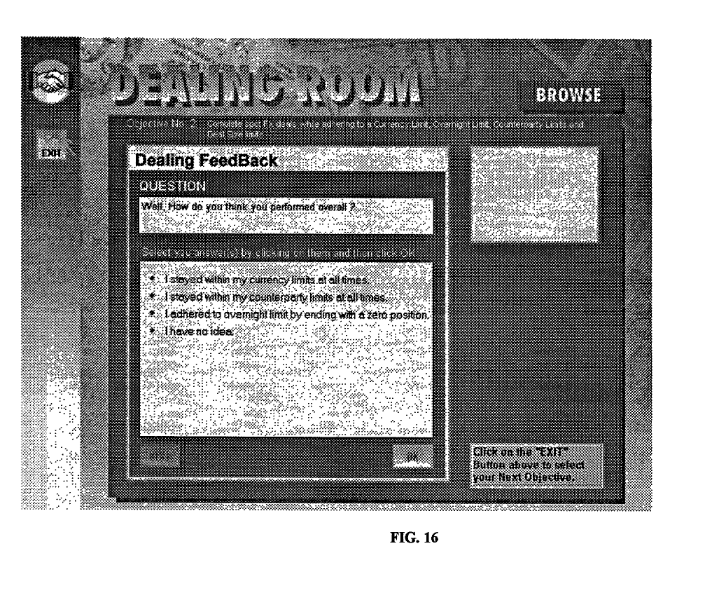

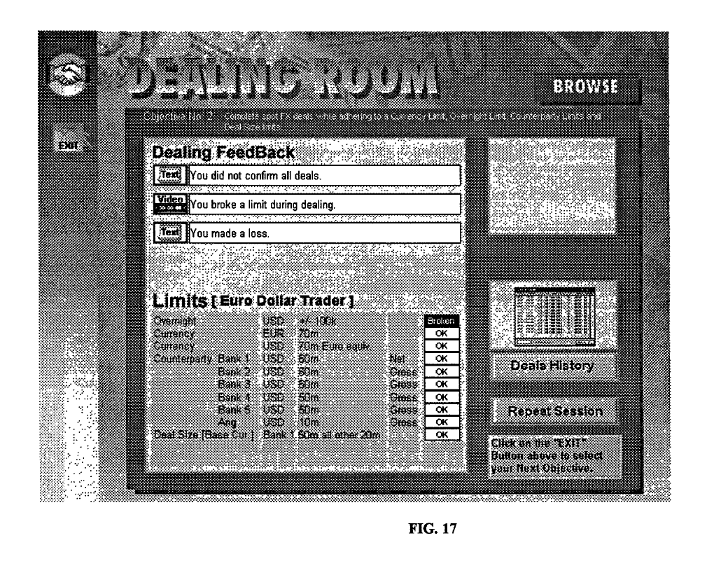

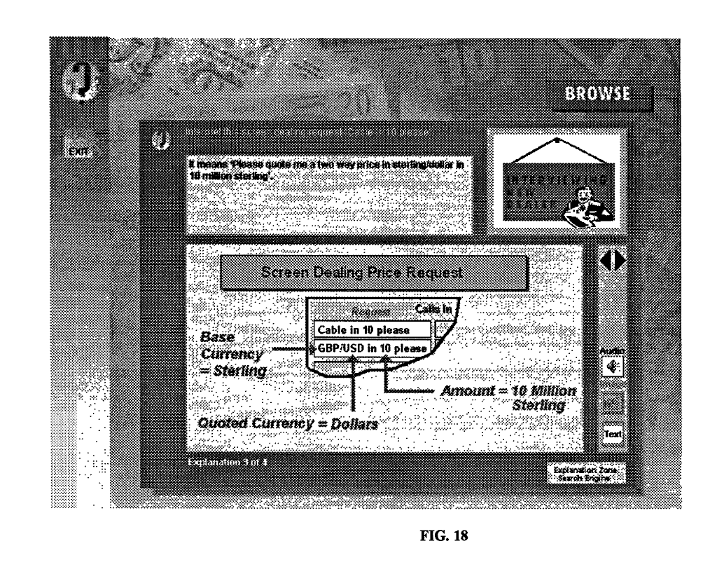

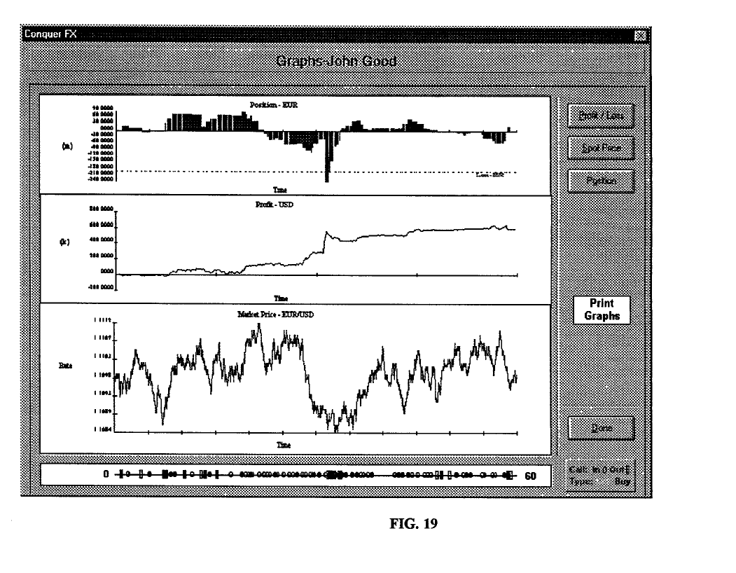

FIGS. 14-18 depict exemplary “master mode” functionality in accordance with the illustrative embodiment of the invention. In particular, FIG. 14 shows a dealing zone constraints and instructions screen. FIG. 15 displays an example of the “master” dealing zone. FIG. 16 shows a request for a student to self-evaluate his/her progress after a simulation session. FIG. 17 shows feedback given to a student after a simulation. And FIG. 18 depicts an exemplary explanation zone screen.

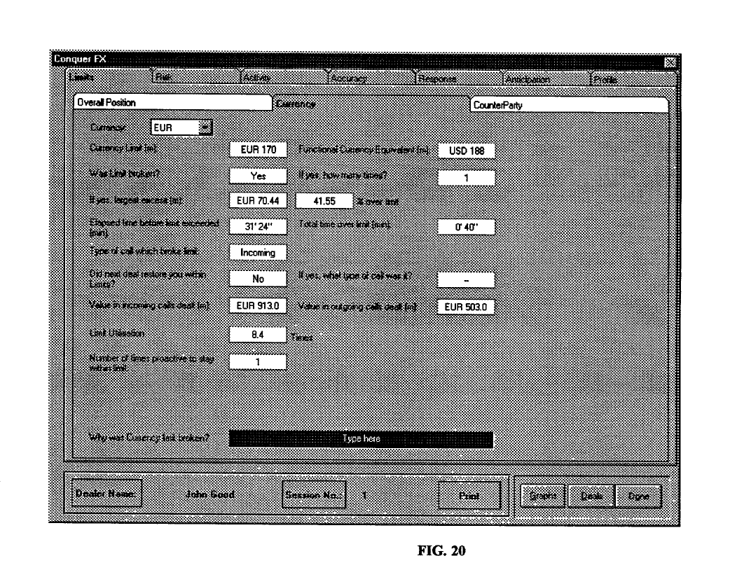

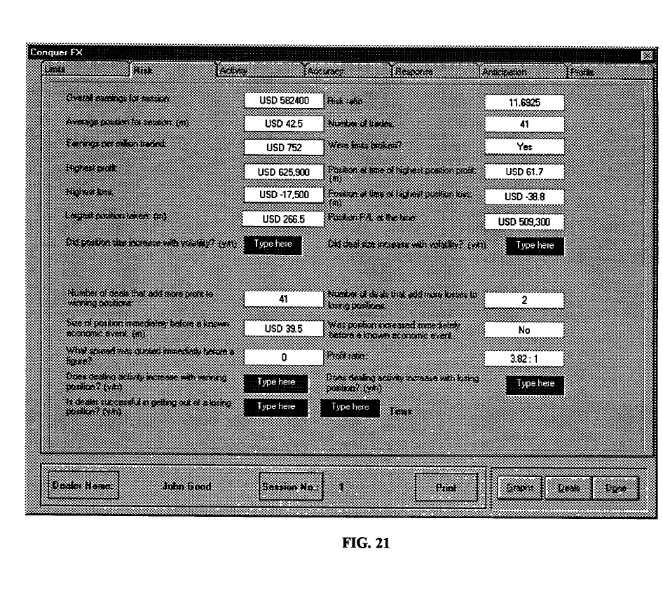

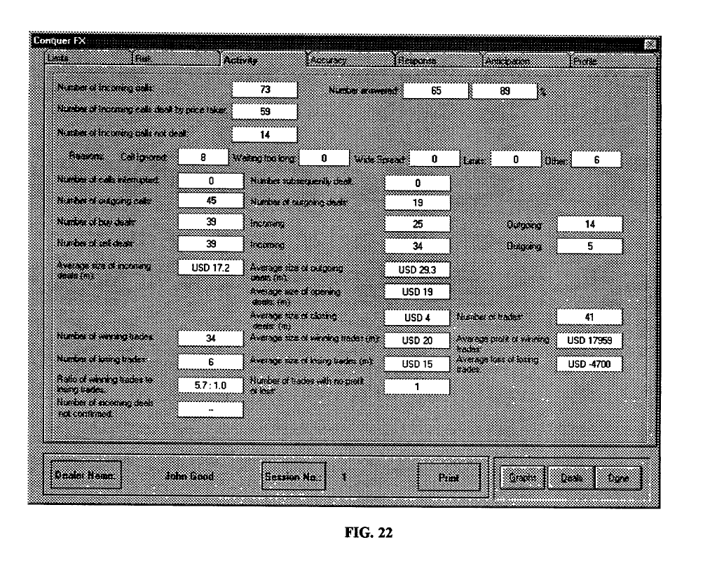

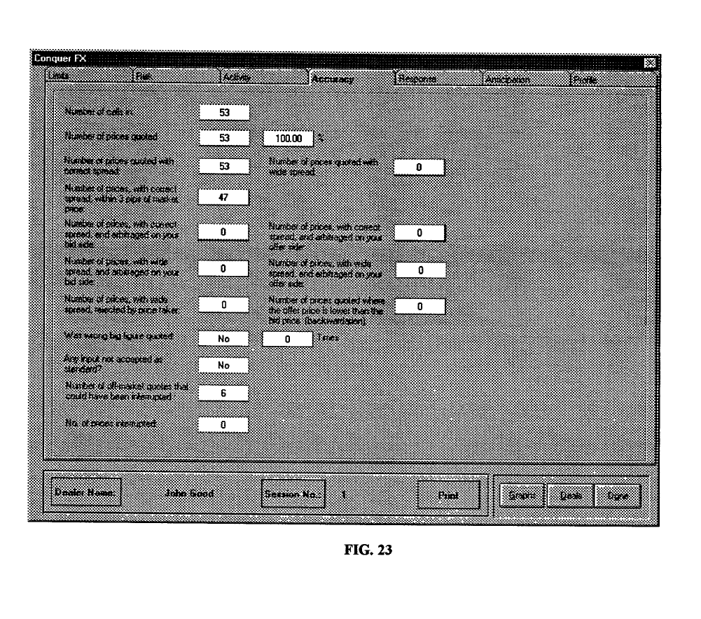

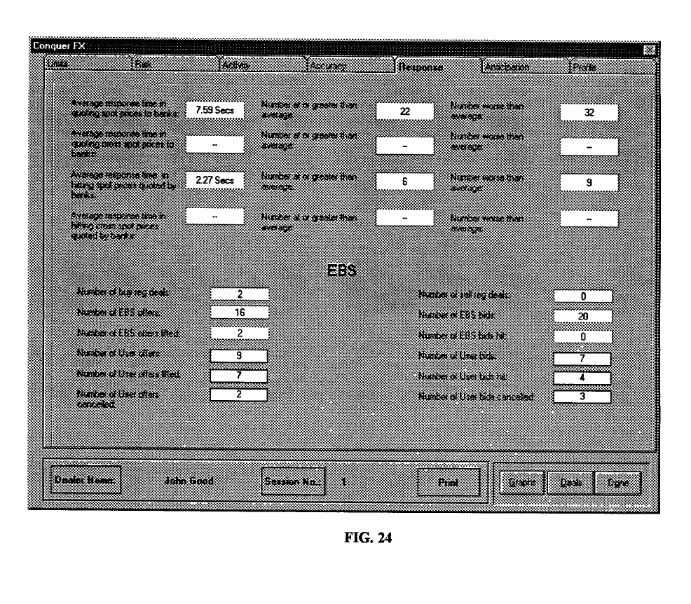

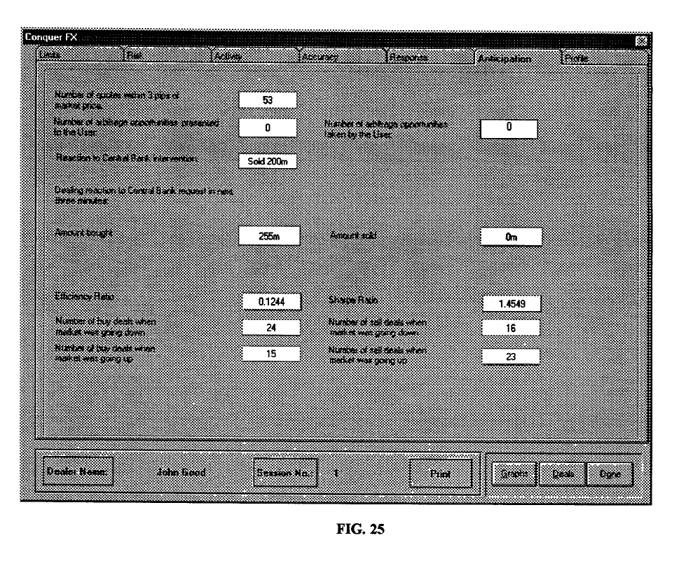

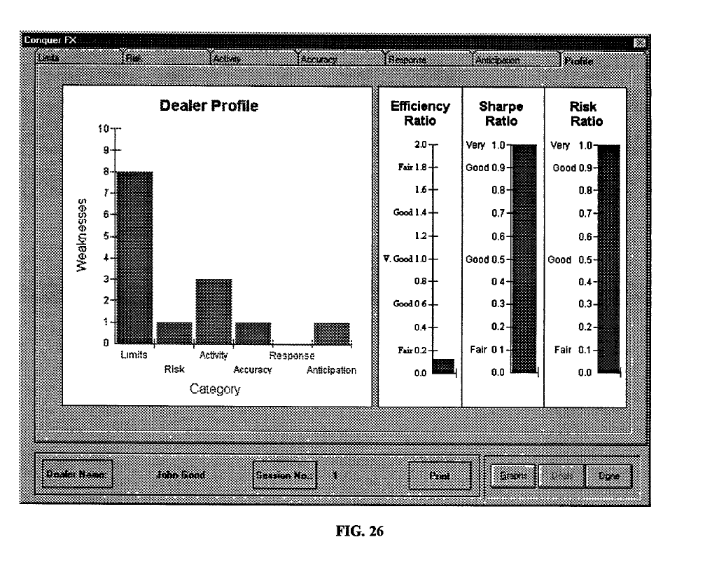

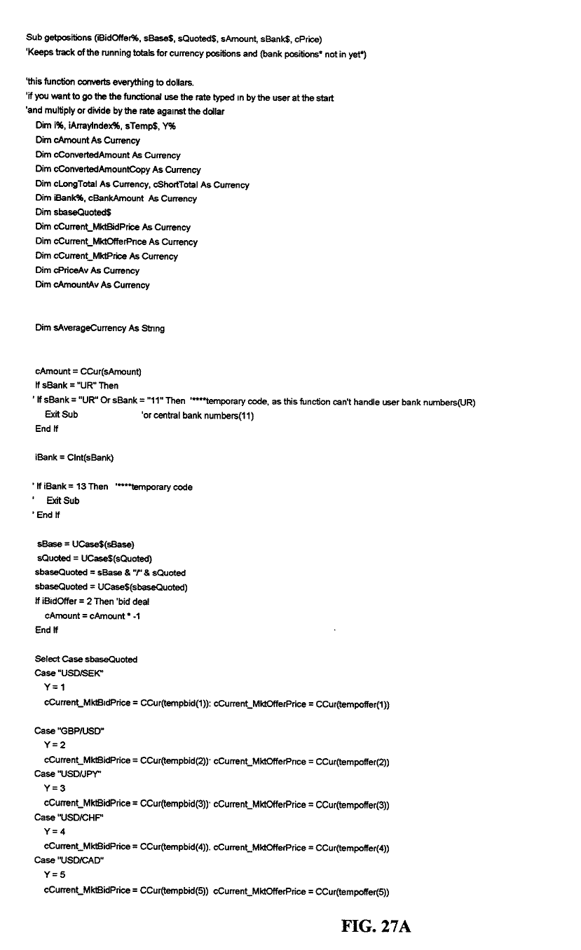

FIGS. 19-26 depict exemplary “conquer mode” functionality in accordance with the illustrative embodiment of the invention. In particular, FIG. 19 displays a detailed breakdown of trading positions throughout a session. FIG. 20 displays feedback on a student's ability to stick within trading limits during a session. FIG. 21 displays an analysis of a student's attitude toward risk during a trading session. FIG. 22 displays an analysis of student trading activity during a session. FIG. 23 displays an analysis of student accuracy for trading. FIG. 24 displays an analysis of student responses to trade requests. FIG. 25 displays an analysis of student willingness to anticipate trades. And FIG. 26 displays a student trading profile.

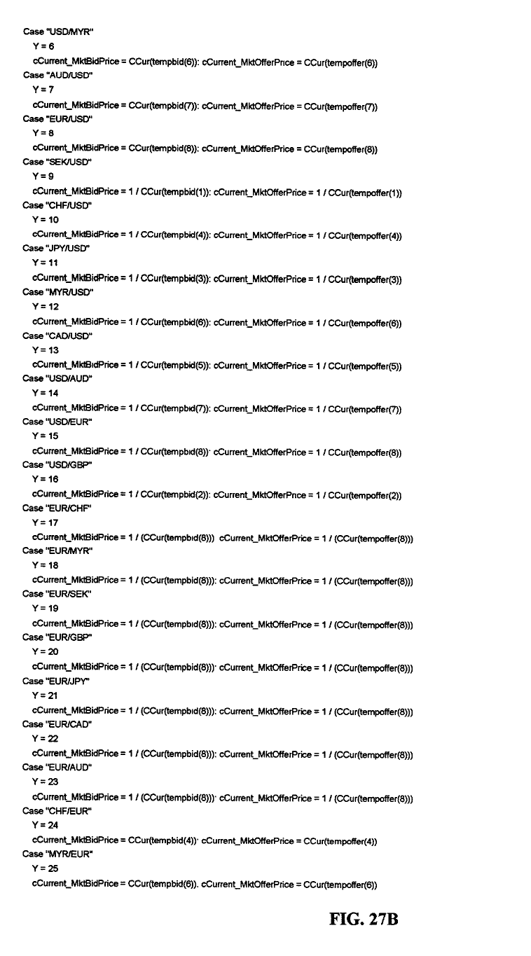

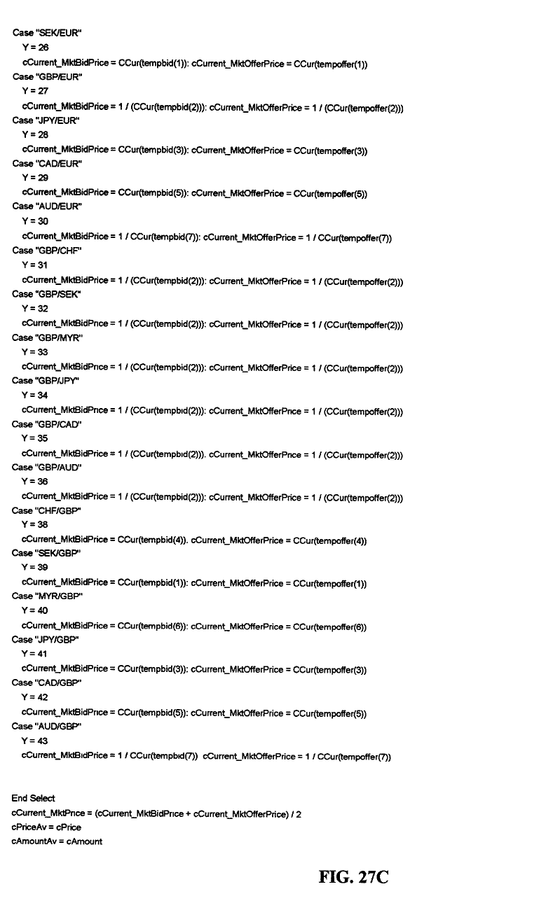

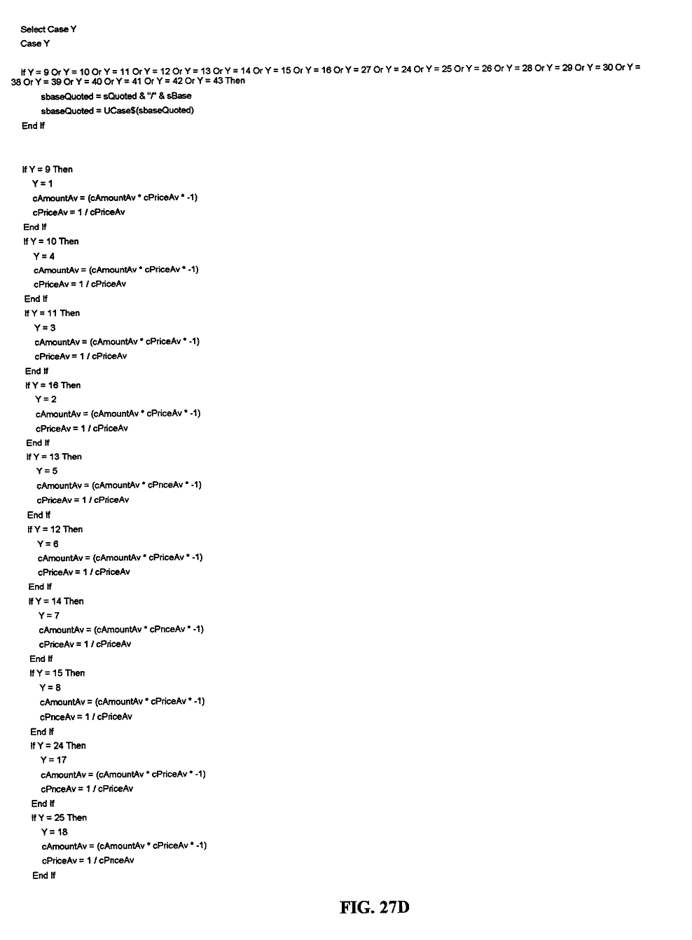

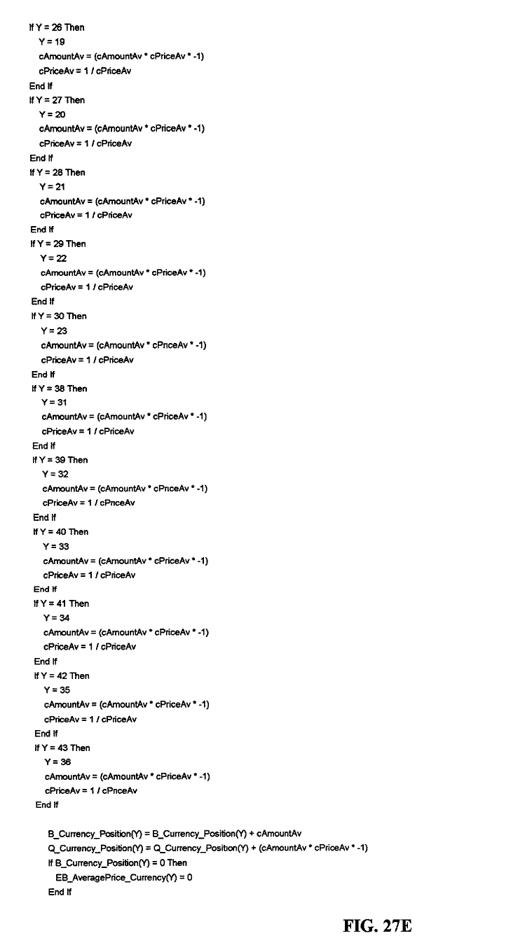

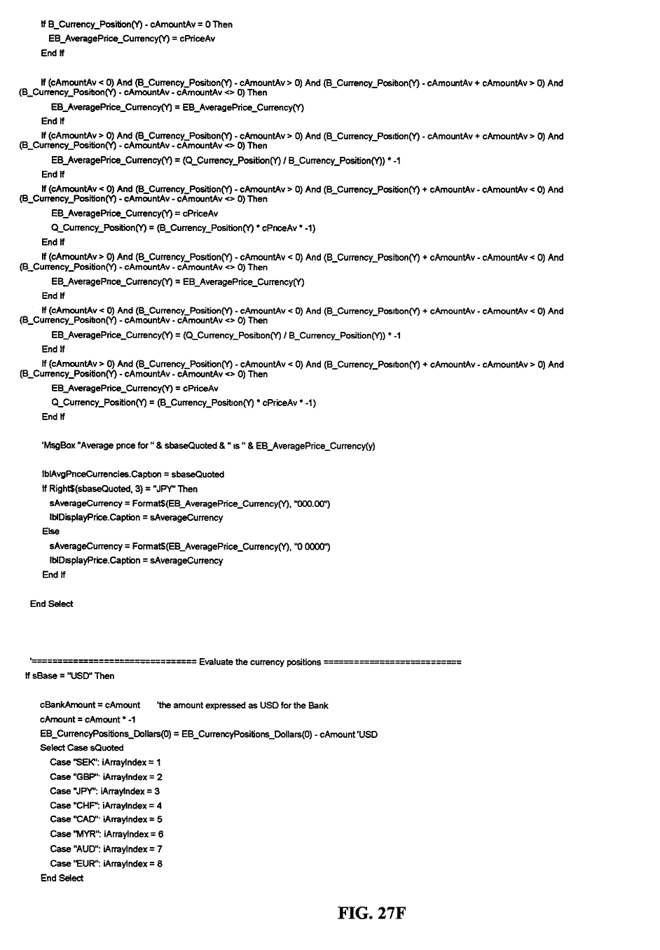

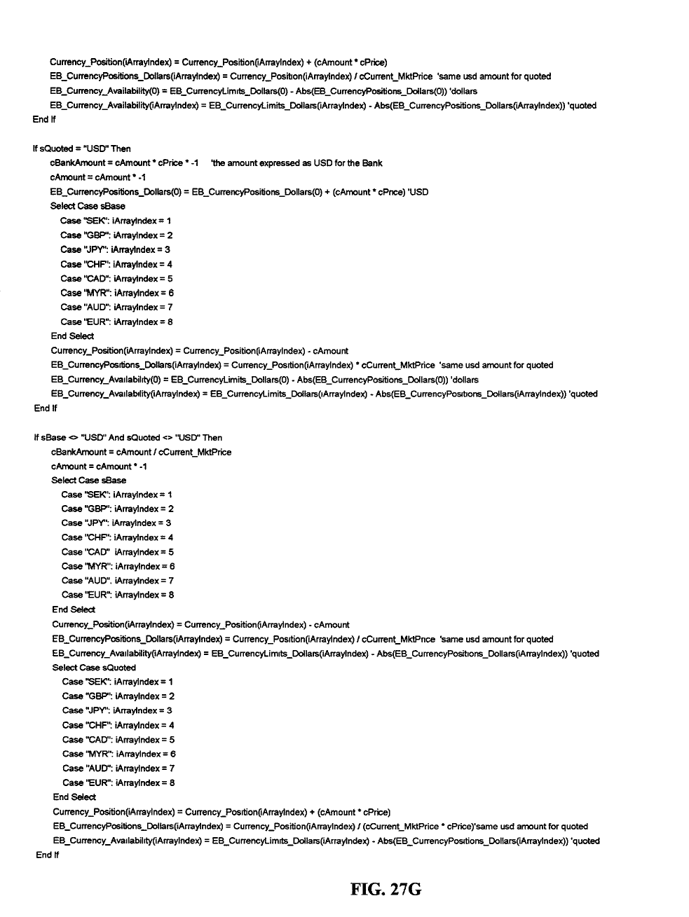

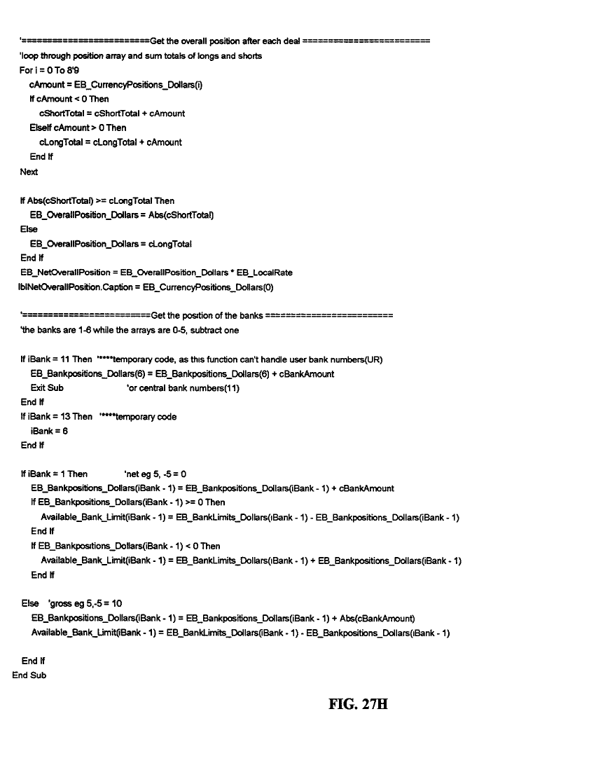

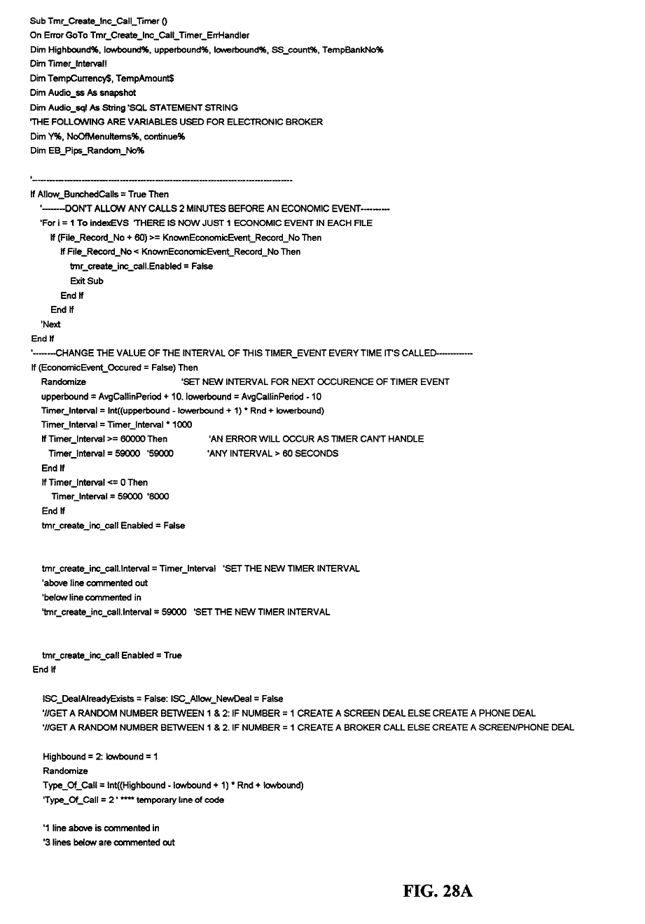

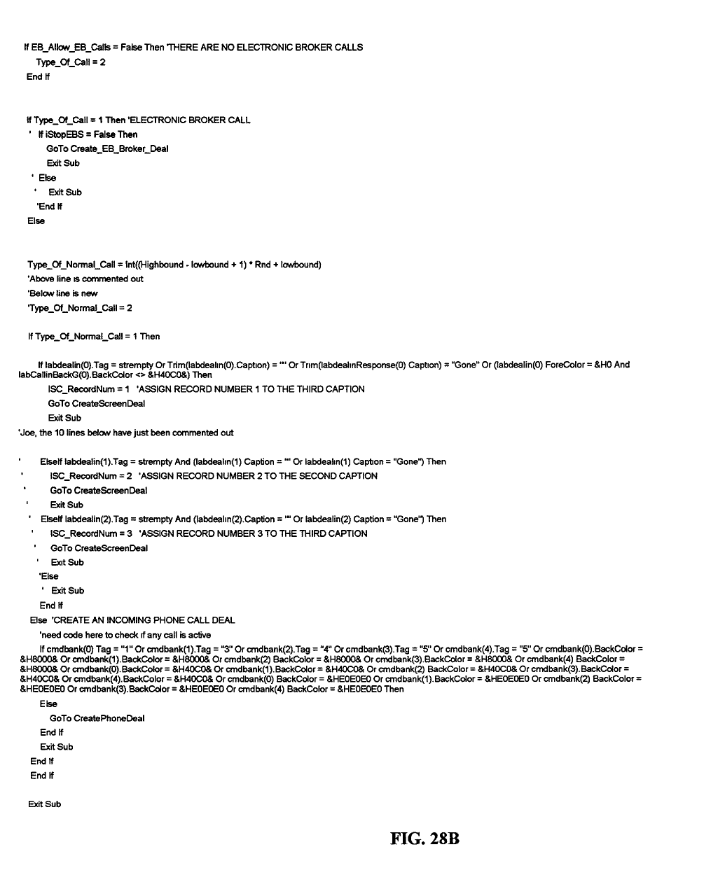

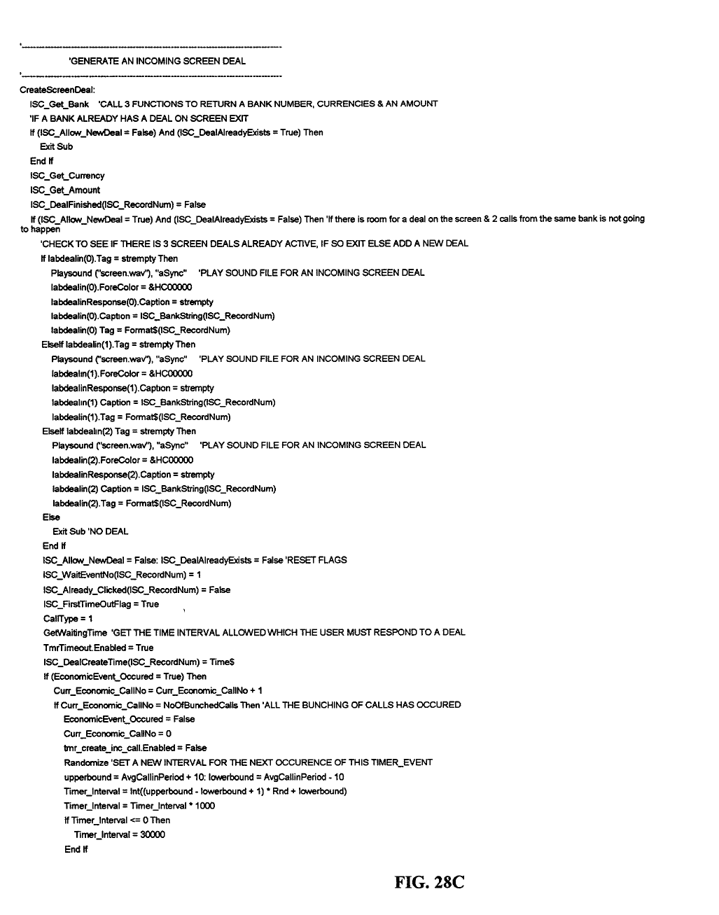

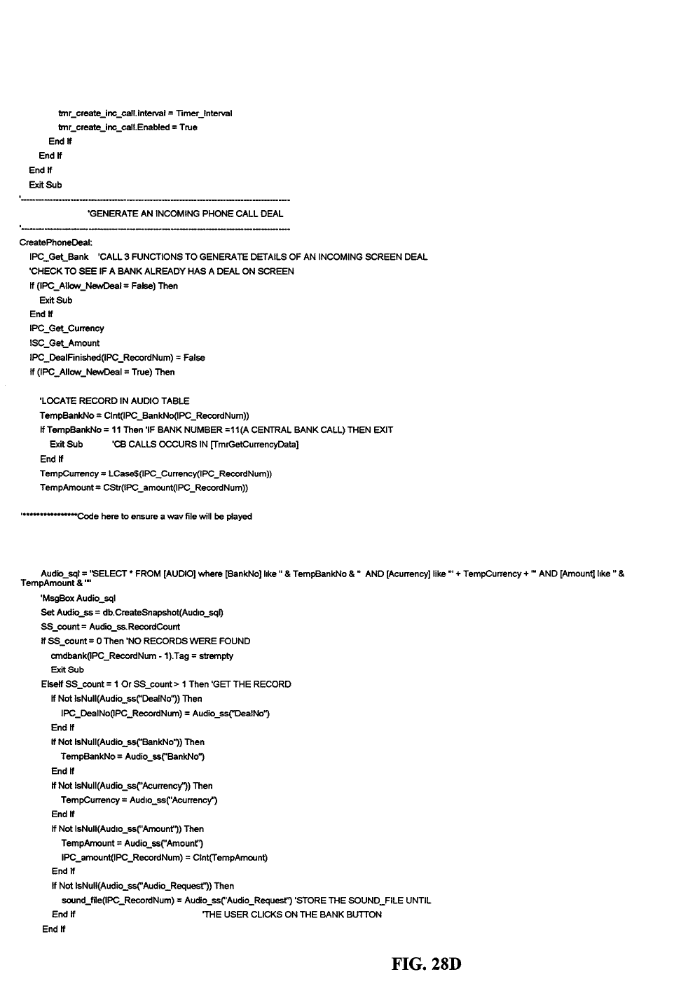

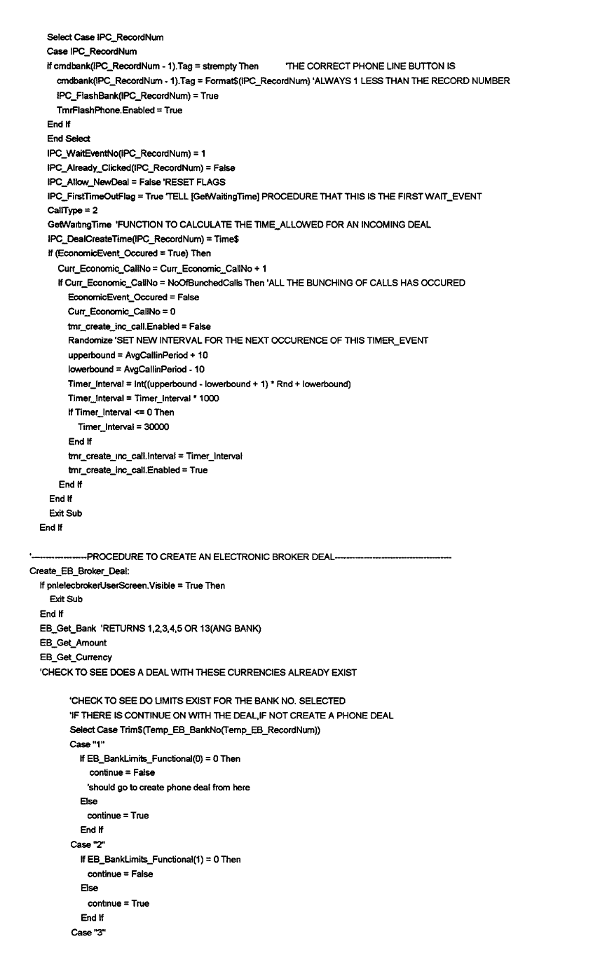

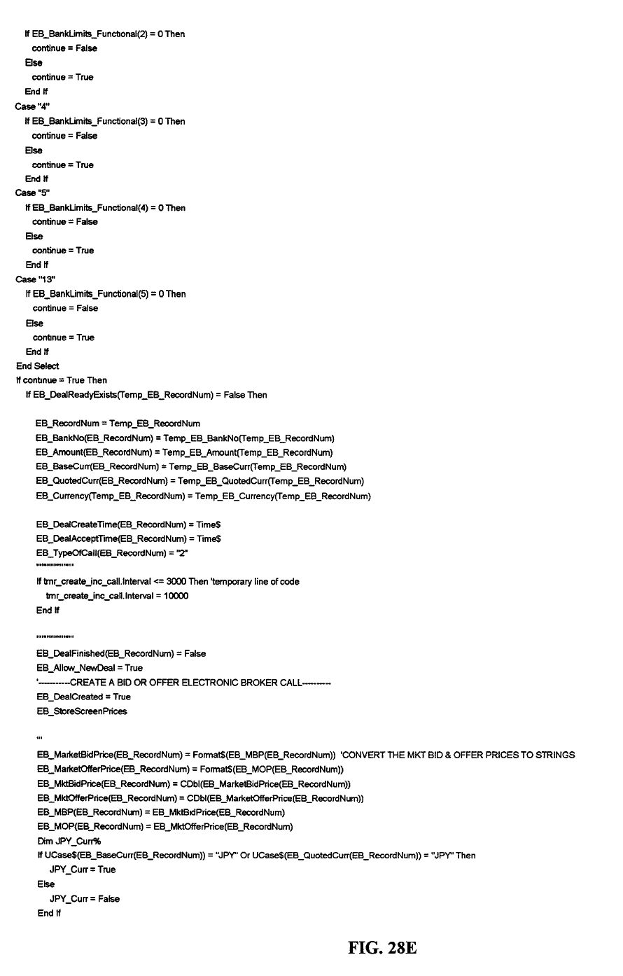

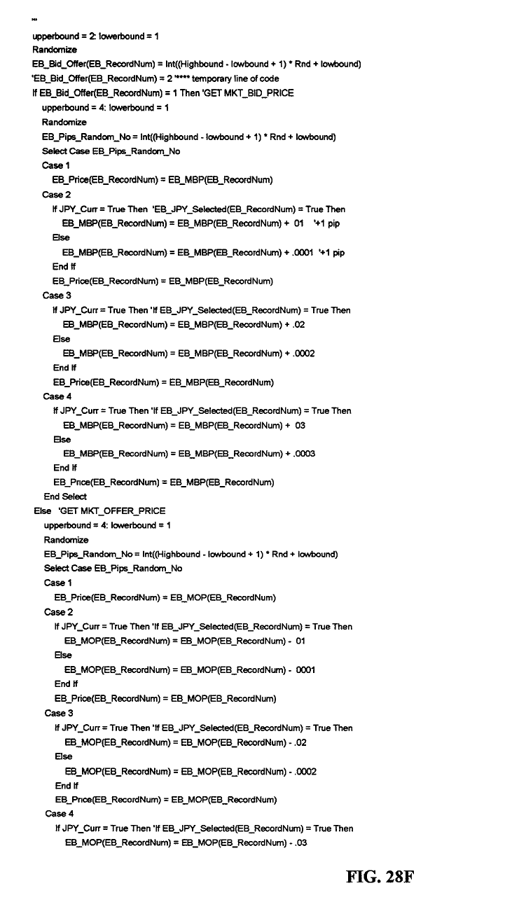

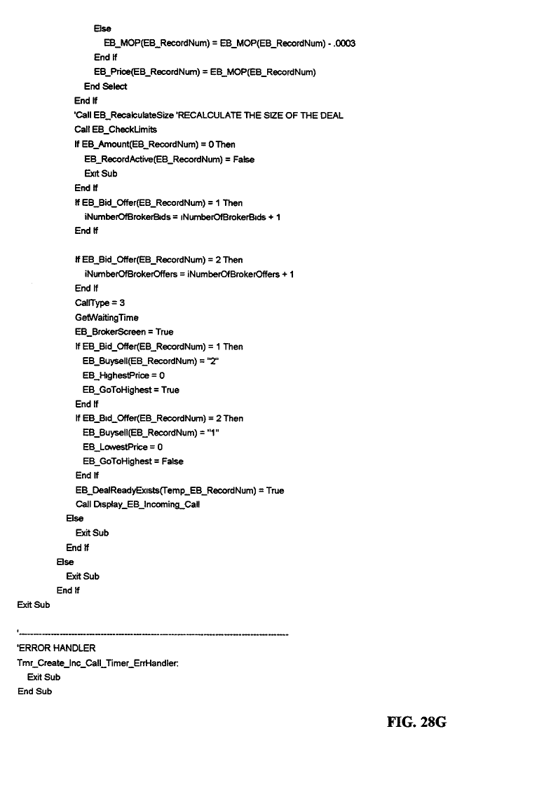

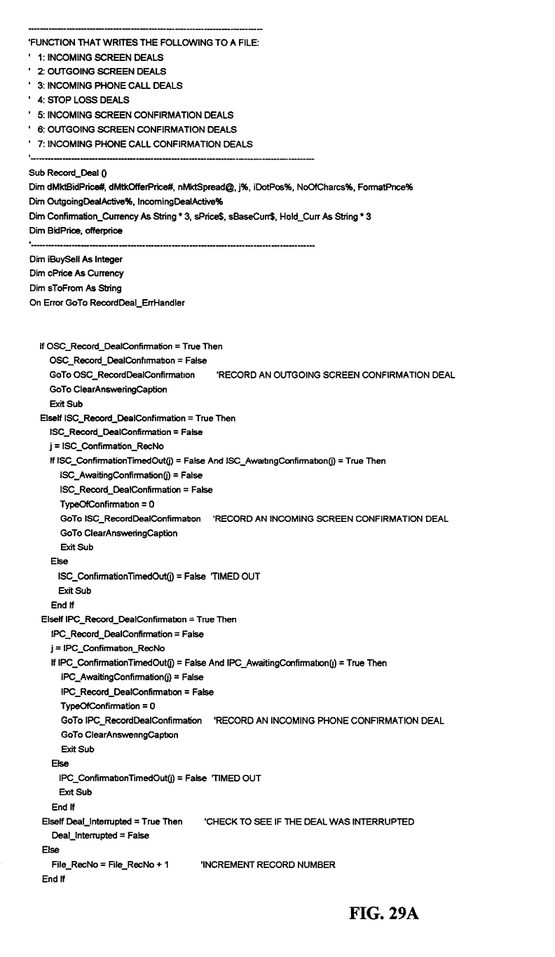

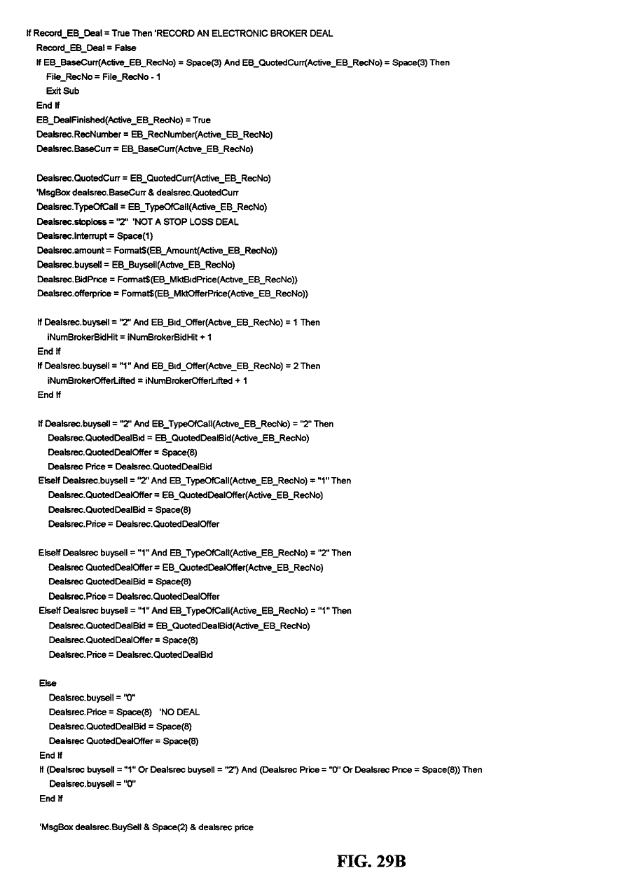

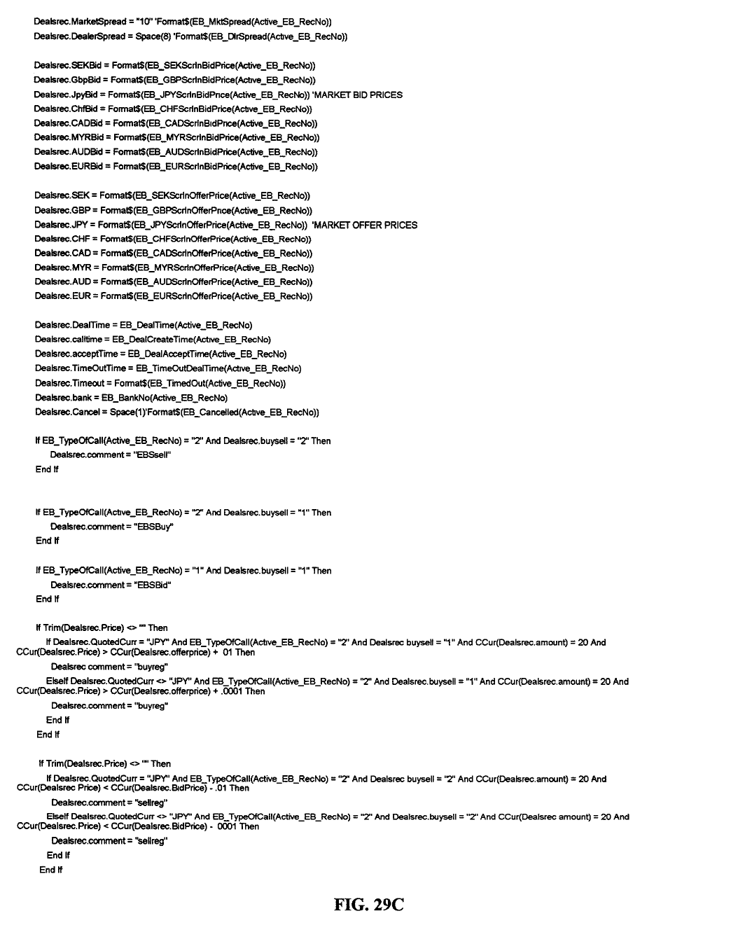

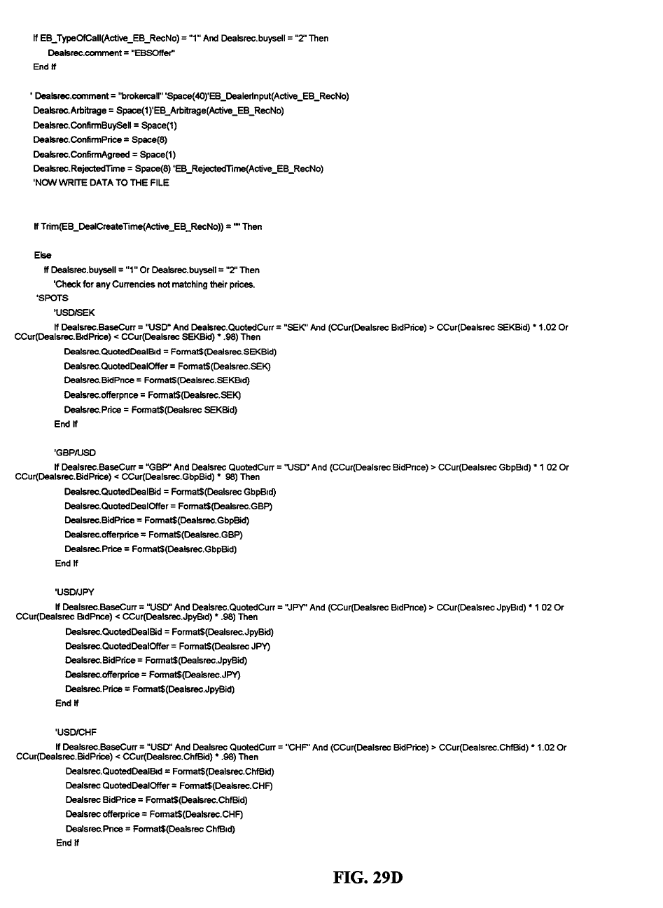

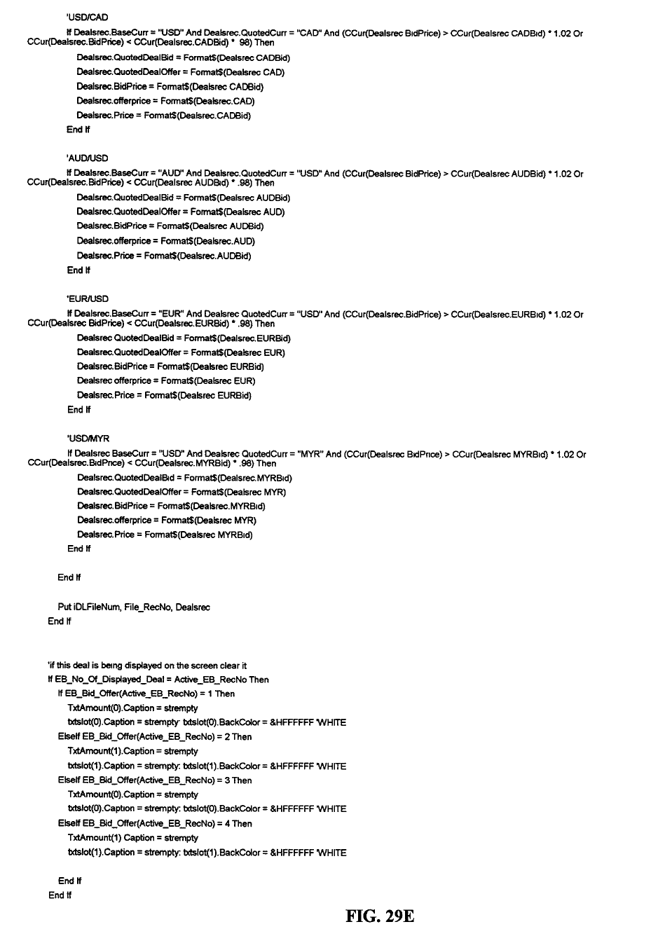

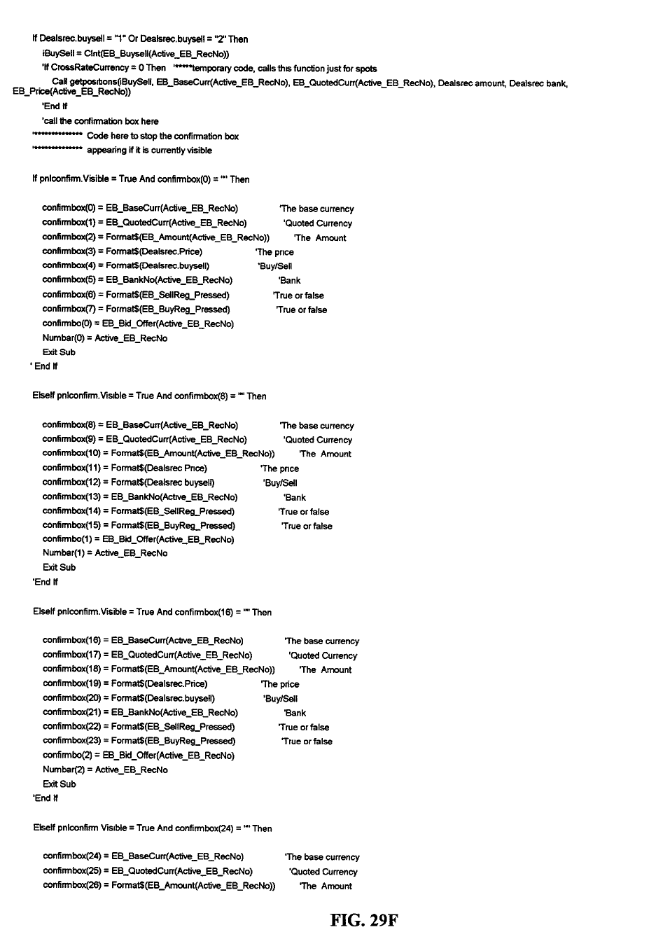

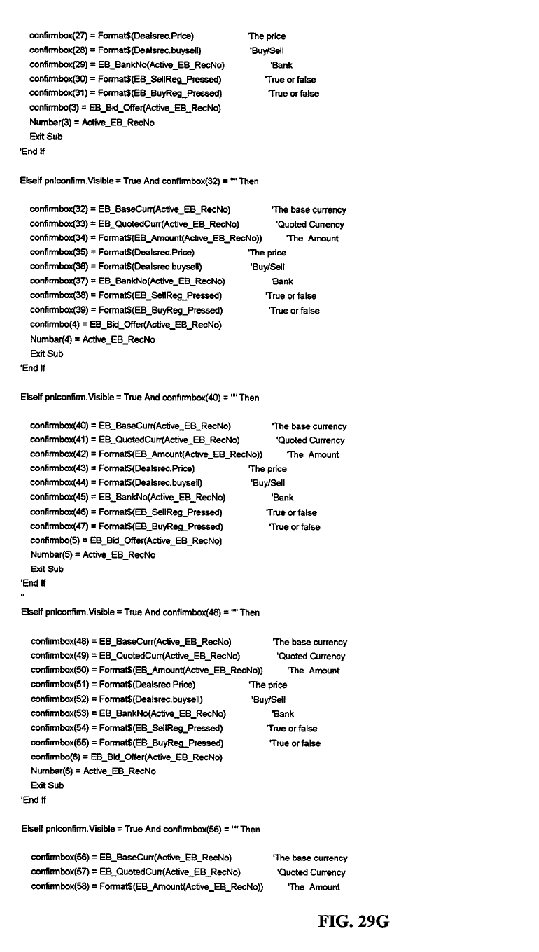

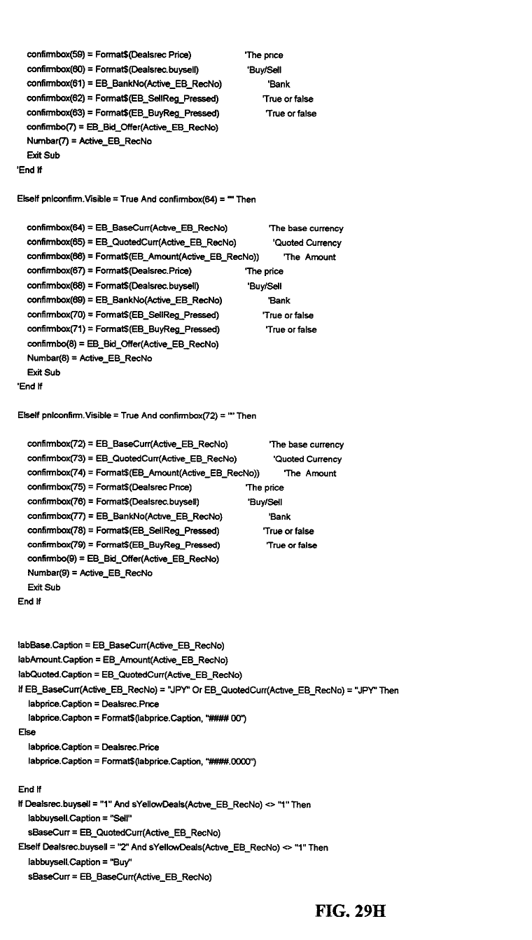

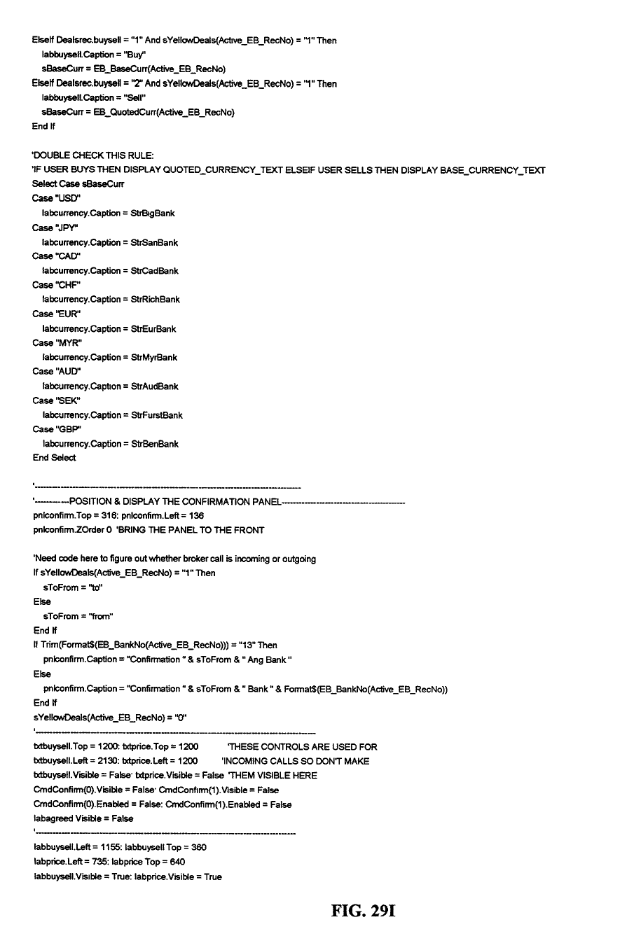

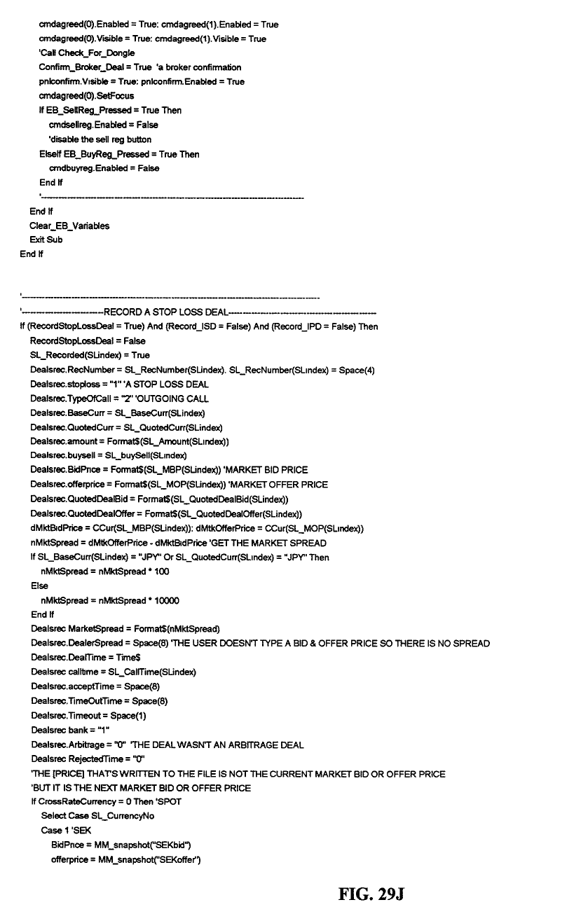

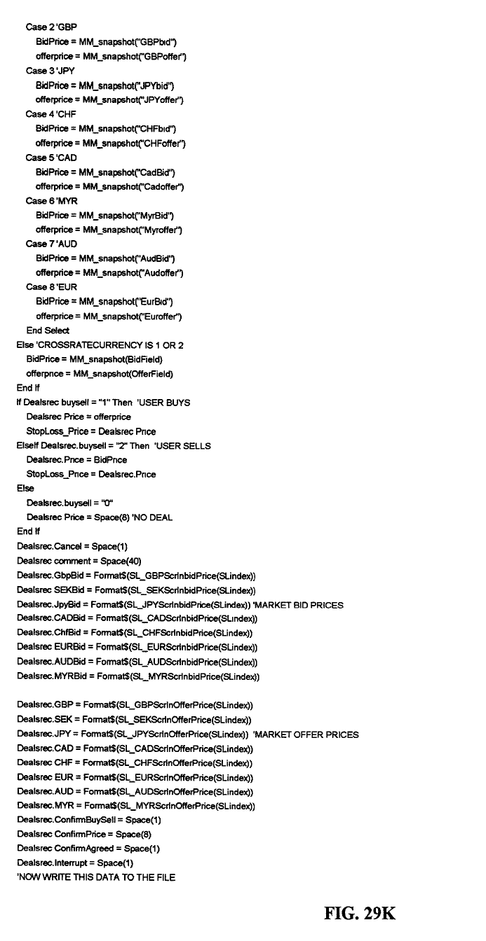

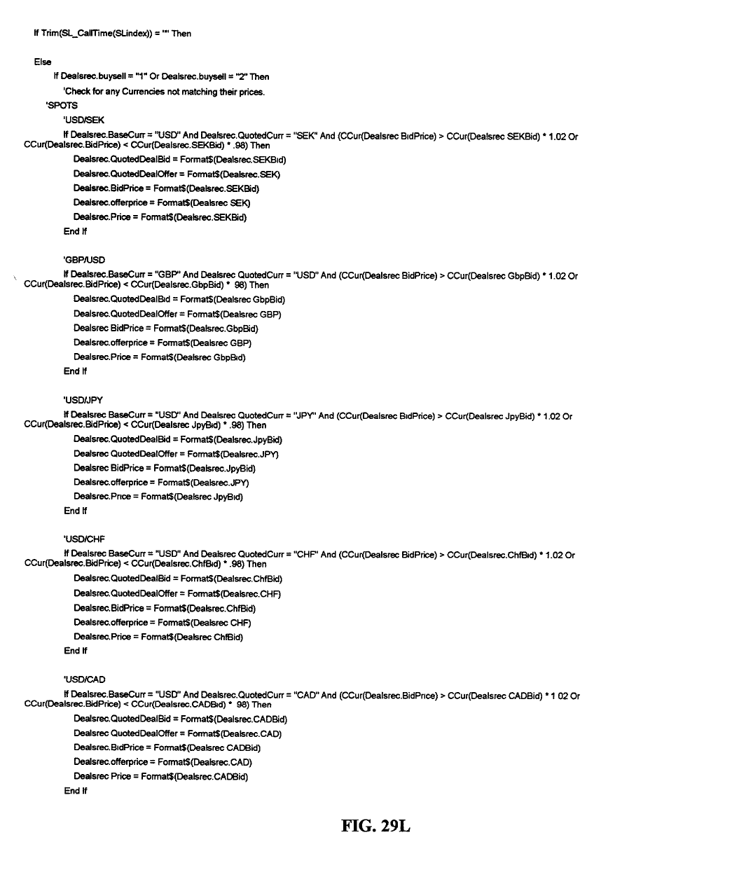

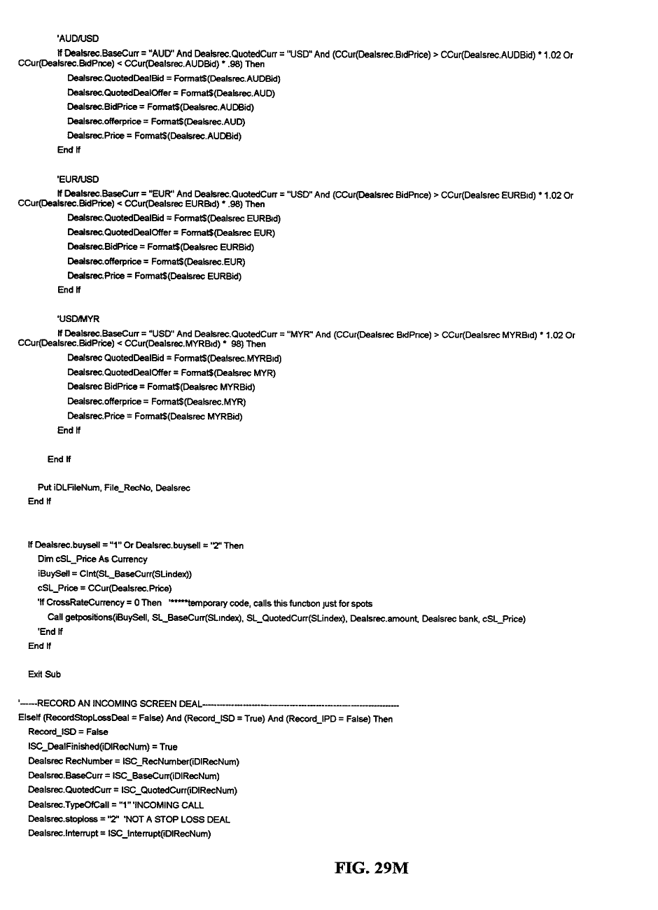

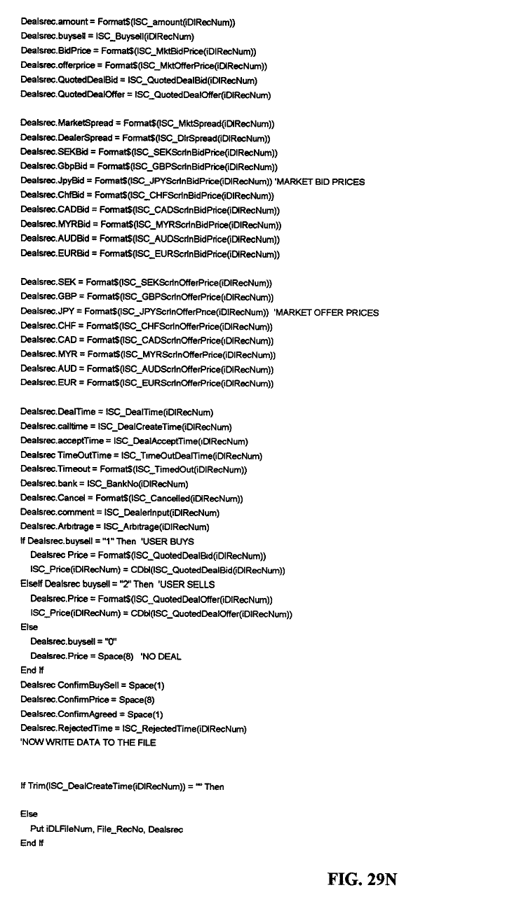

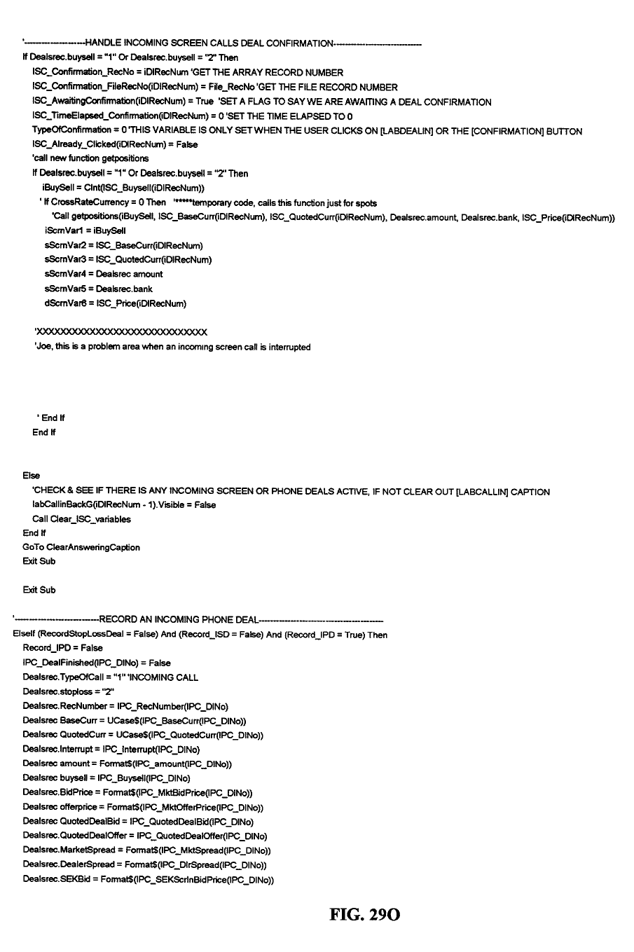

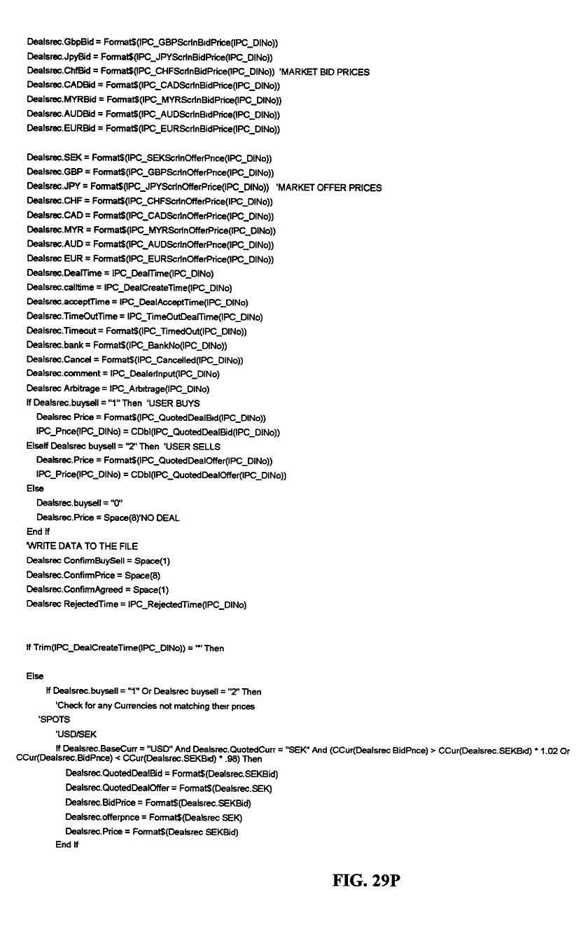

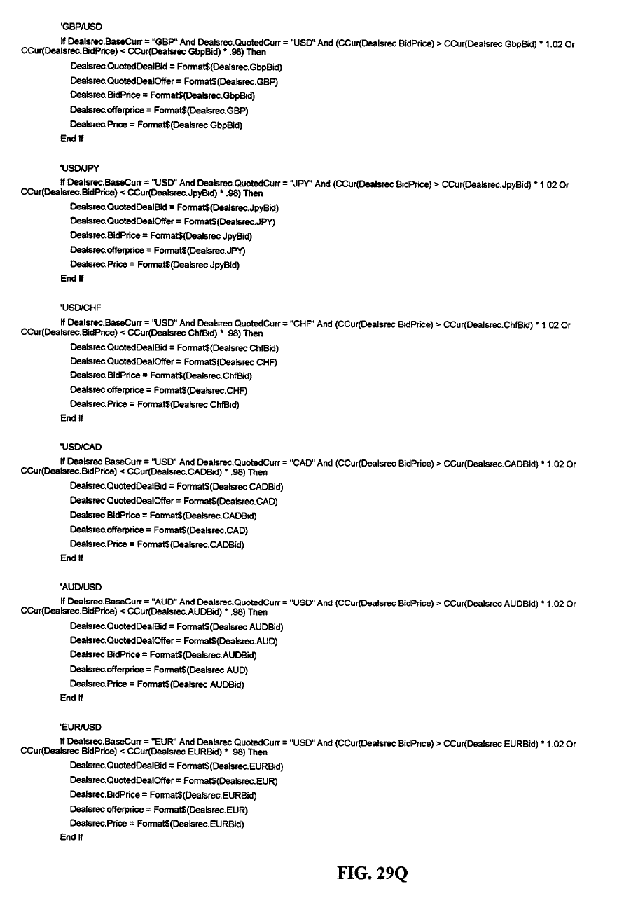

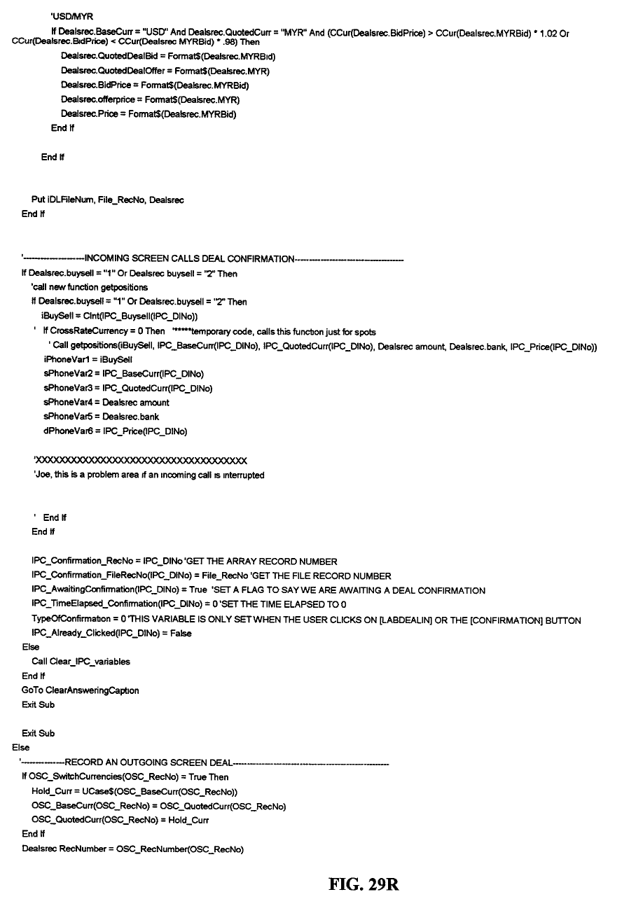

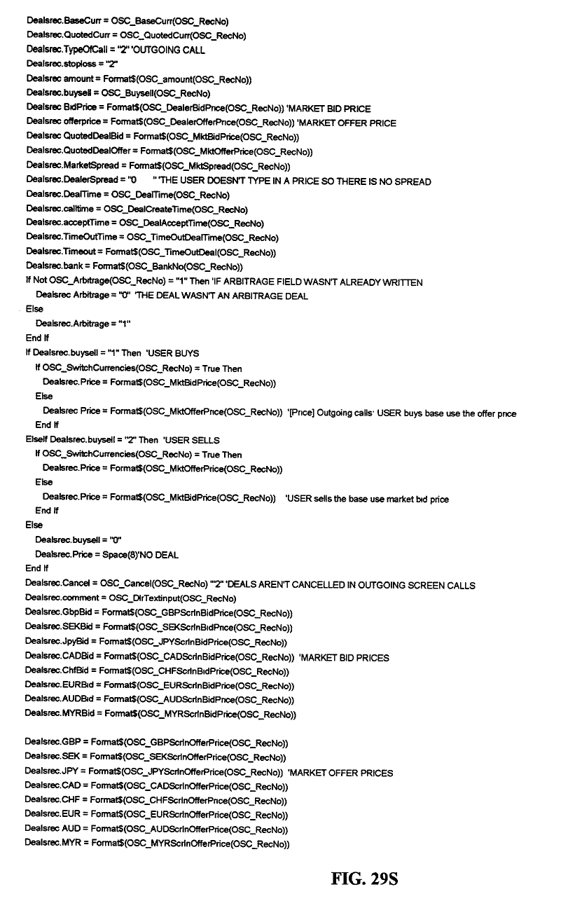

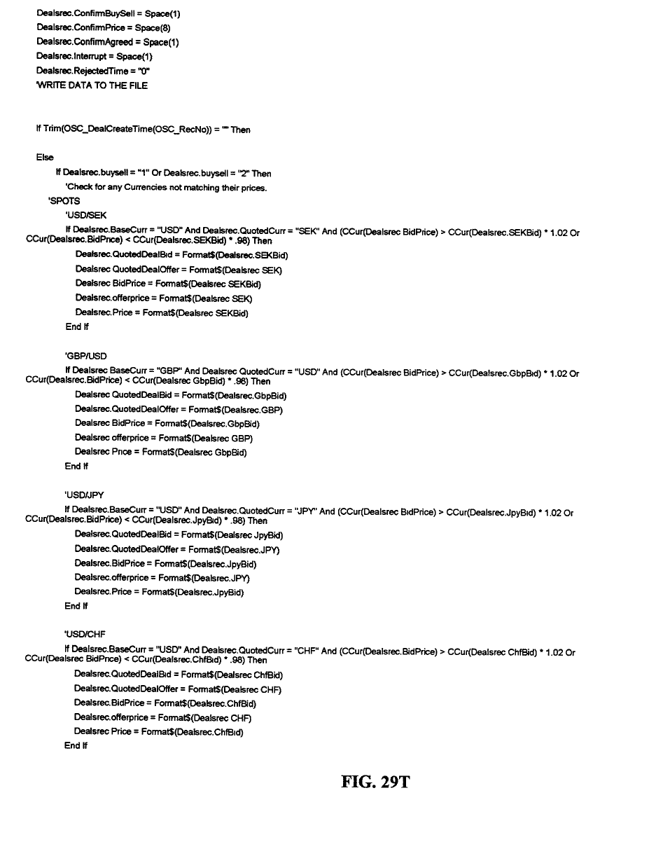

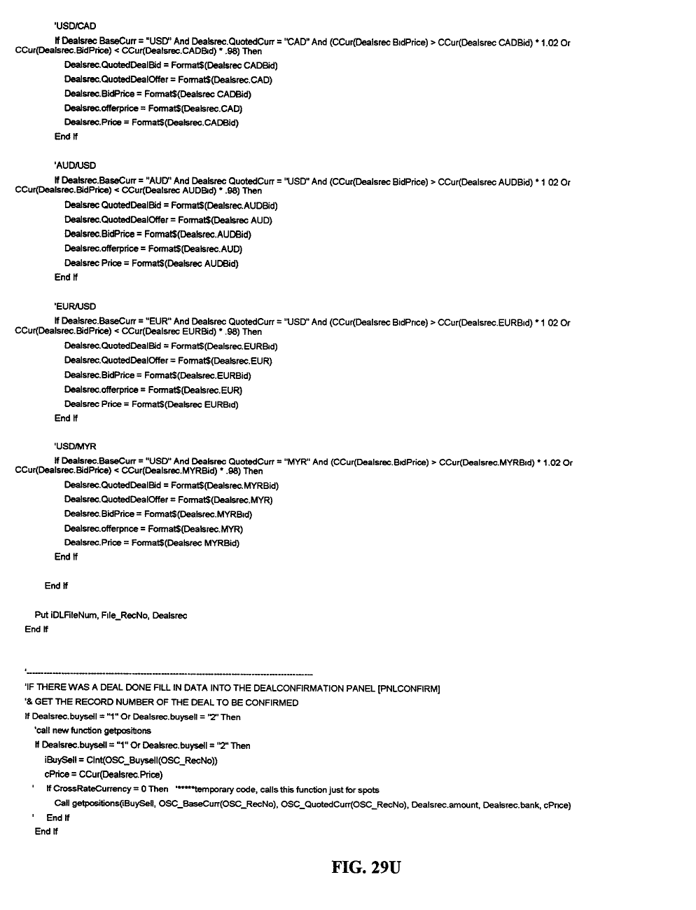

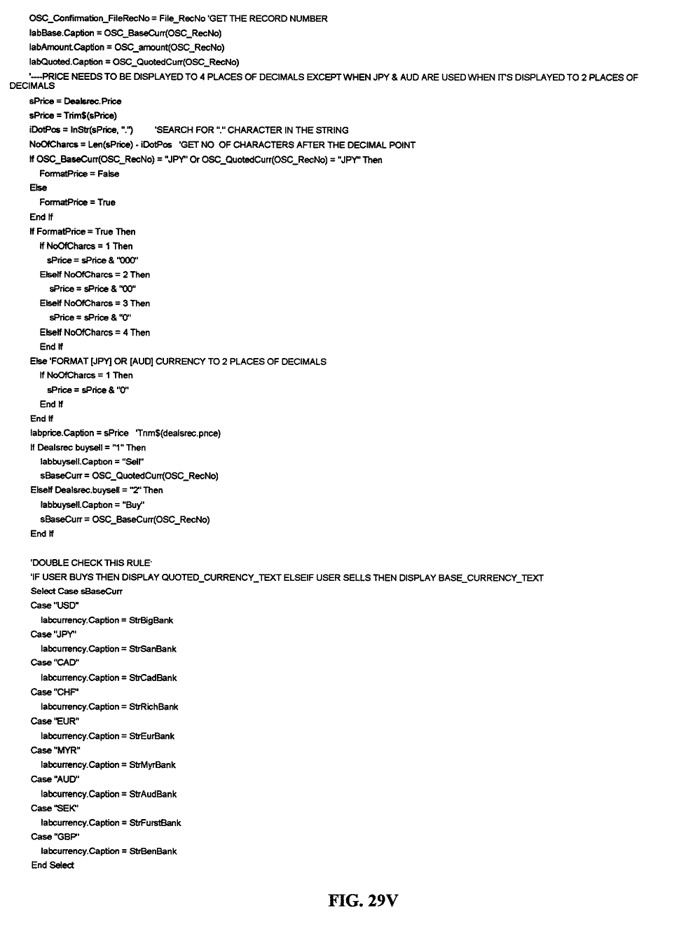

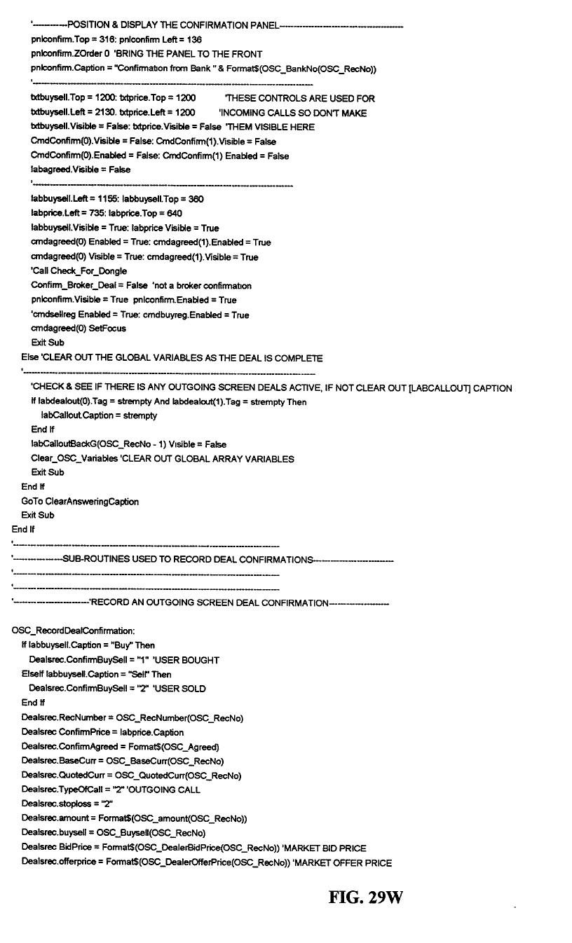

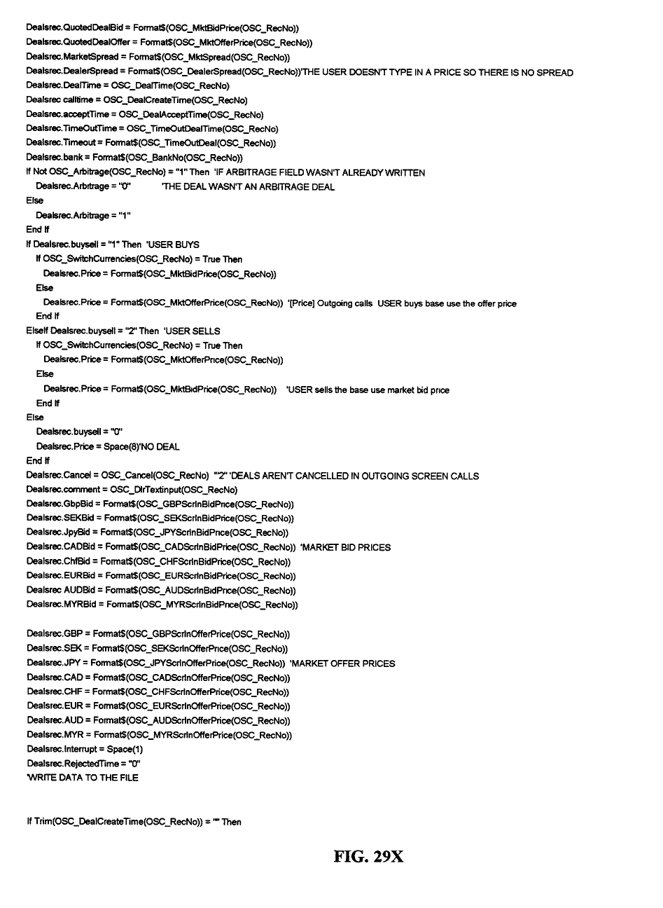

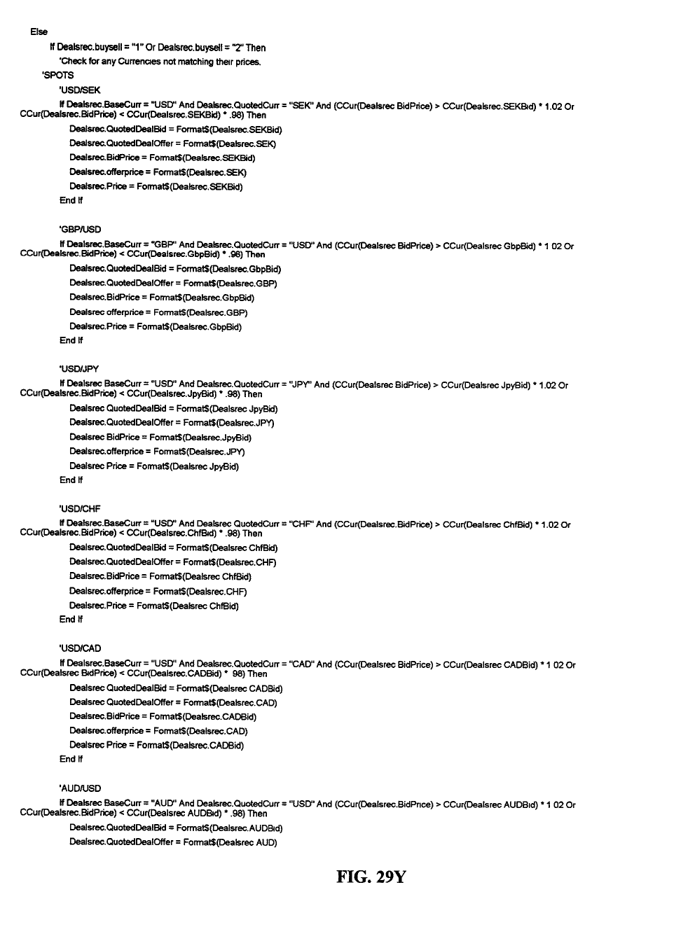

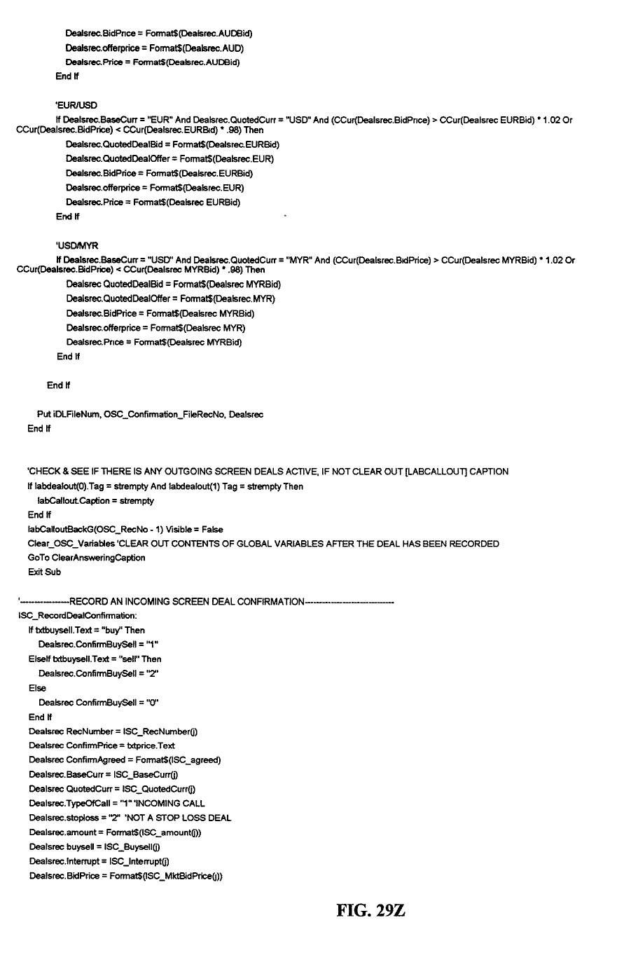

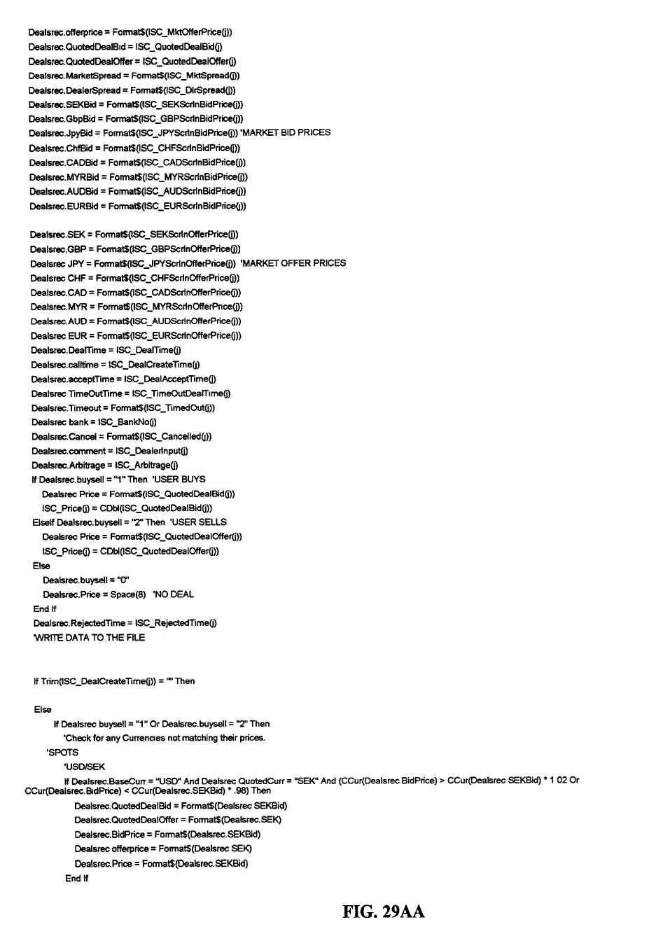

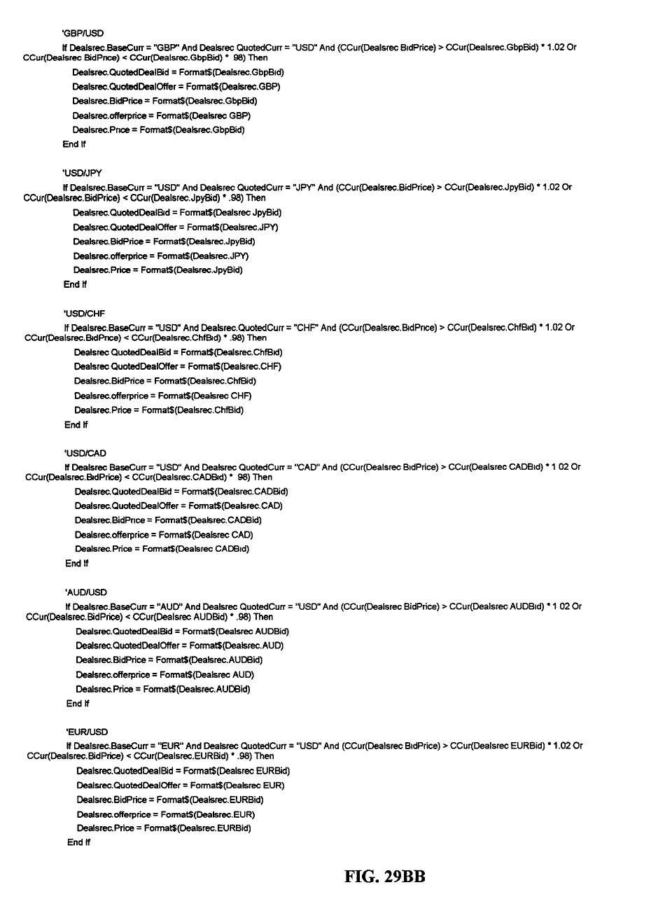

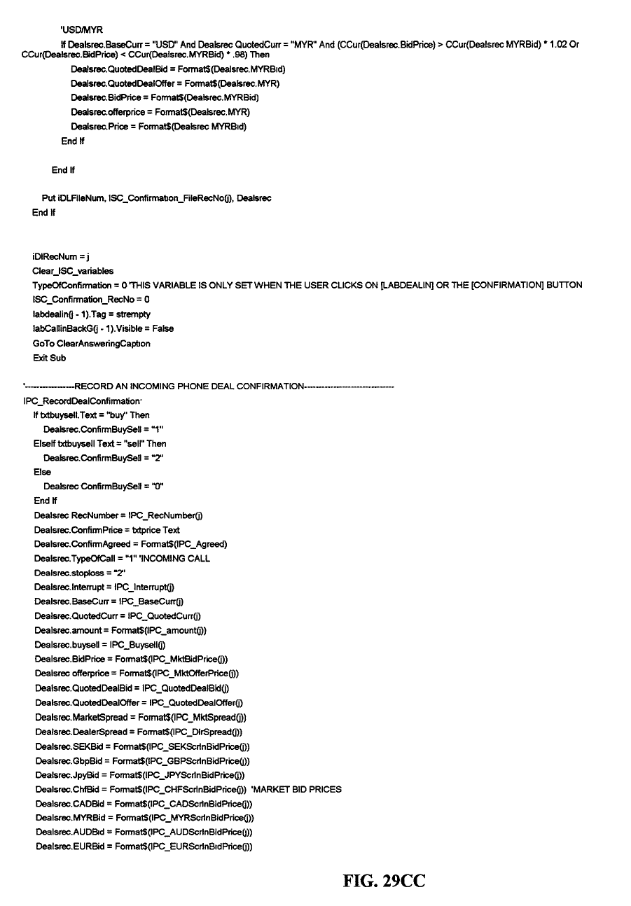

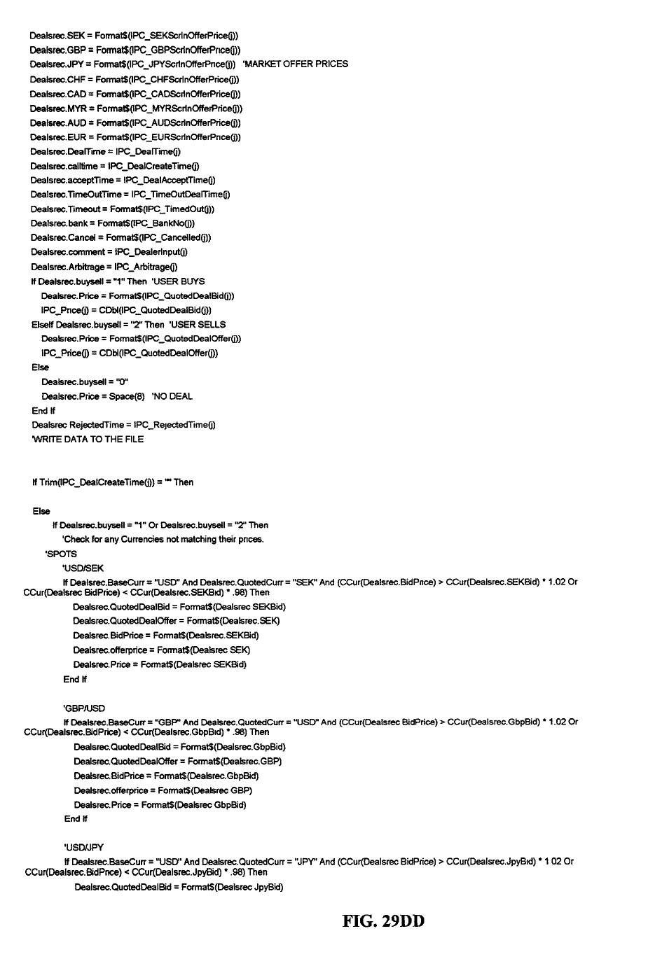

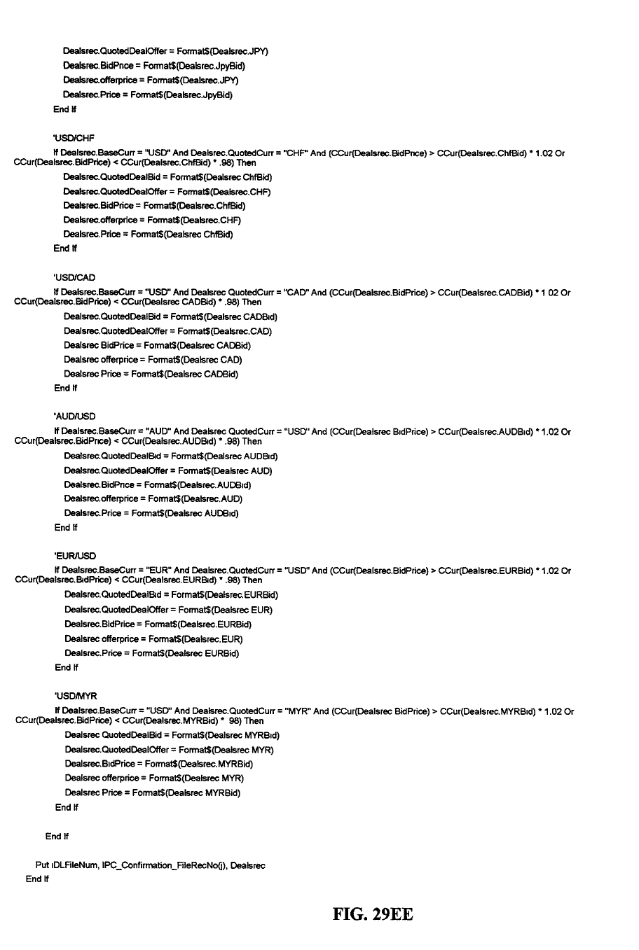

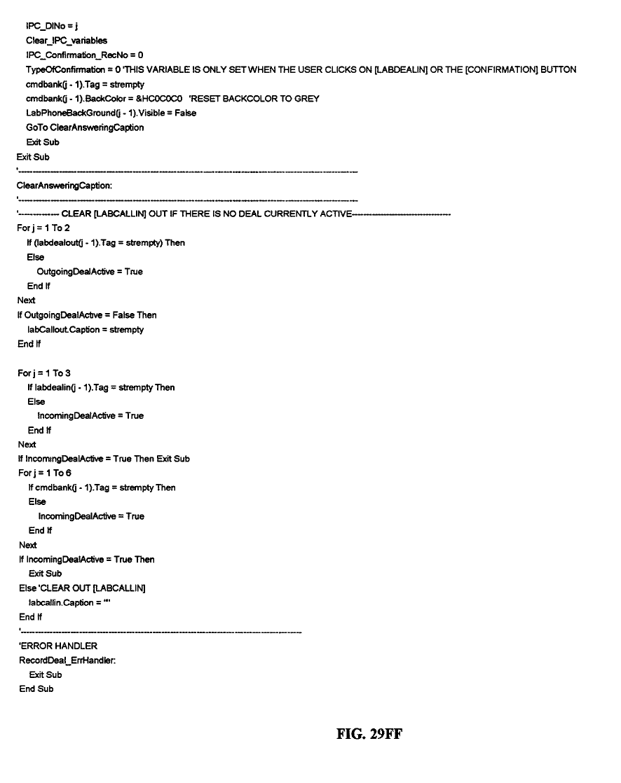

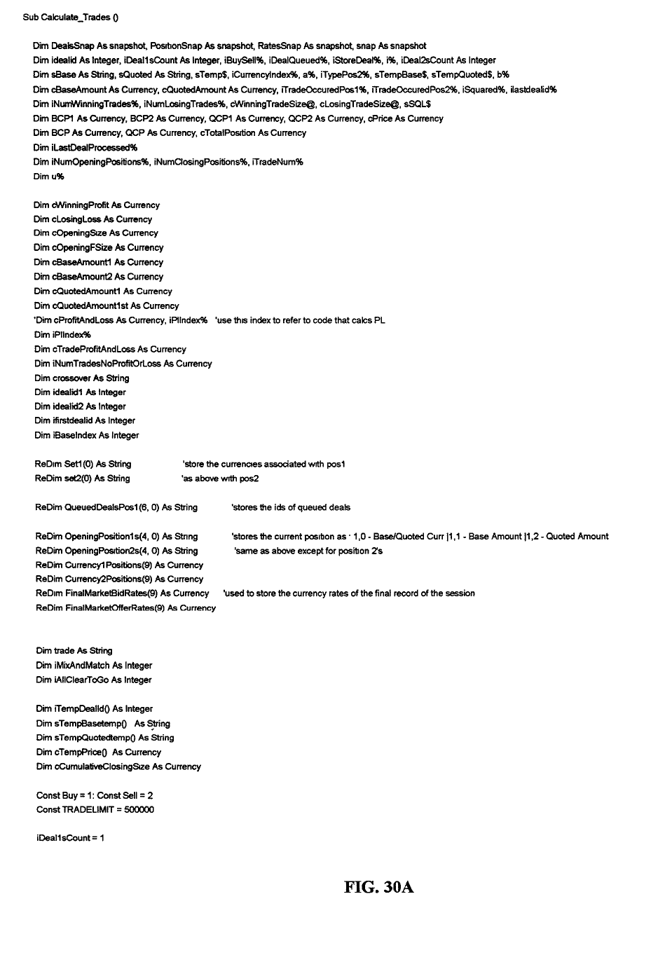

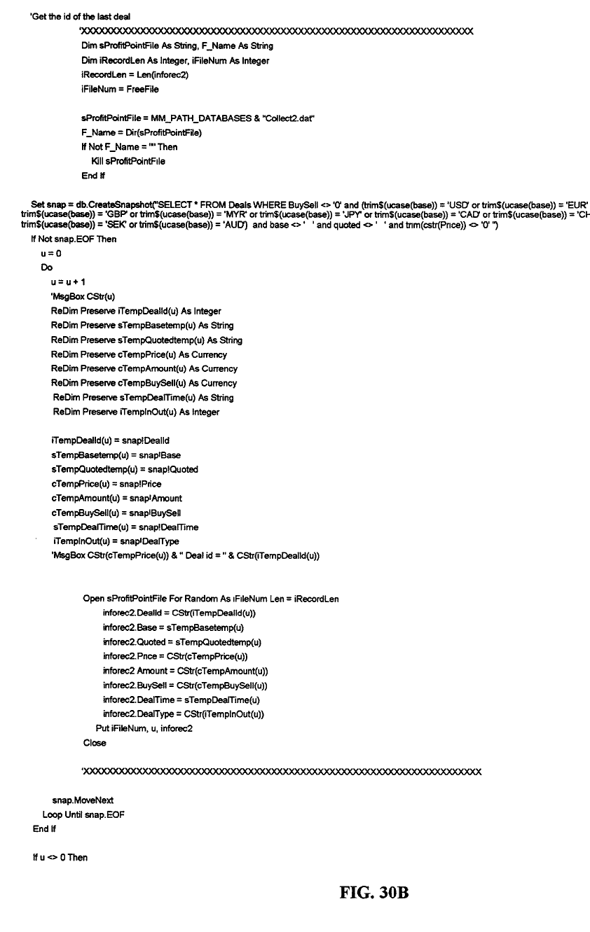

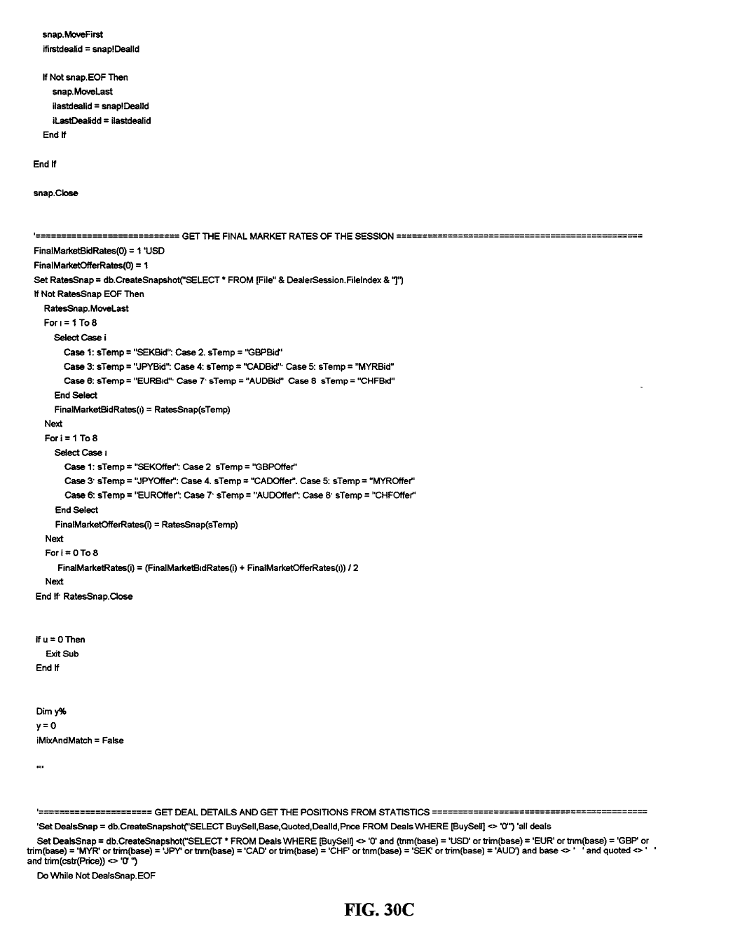

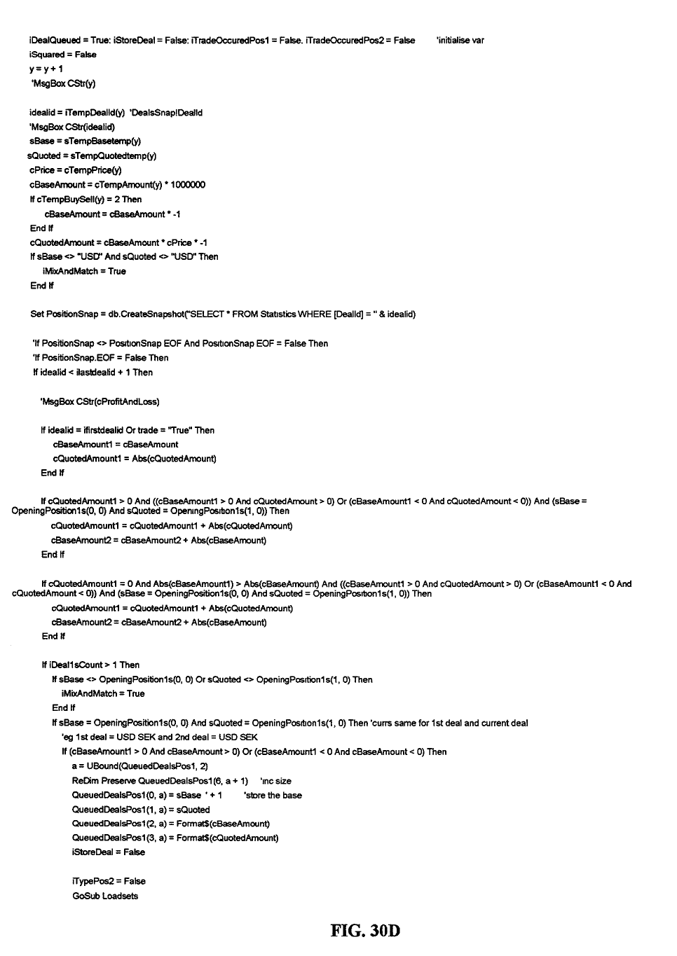

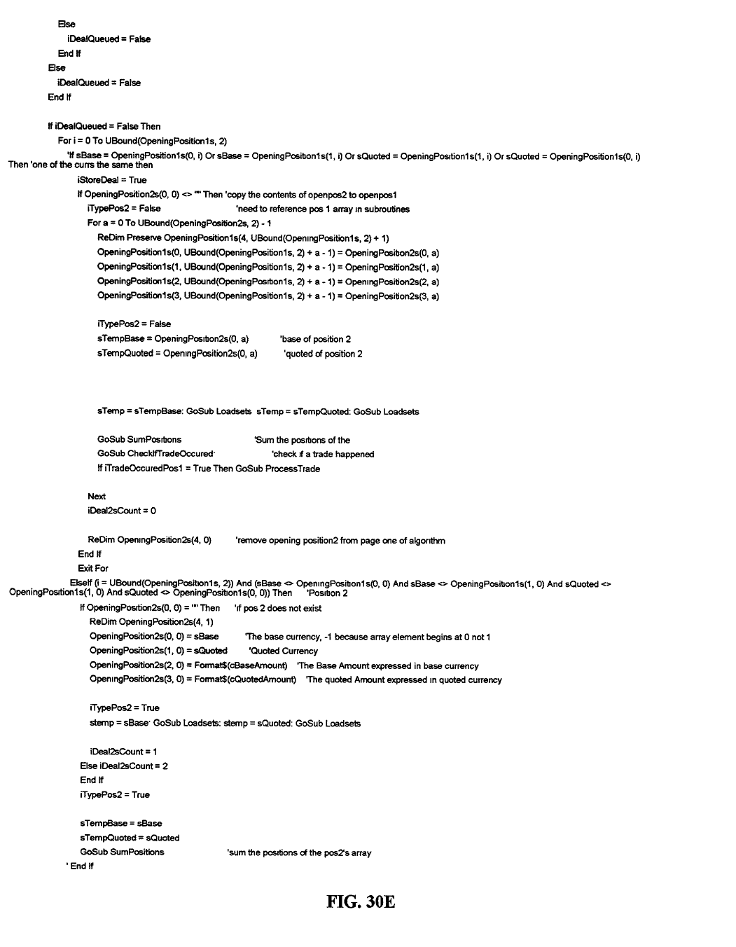

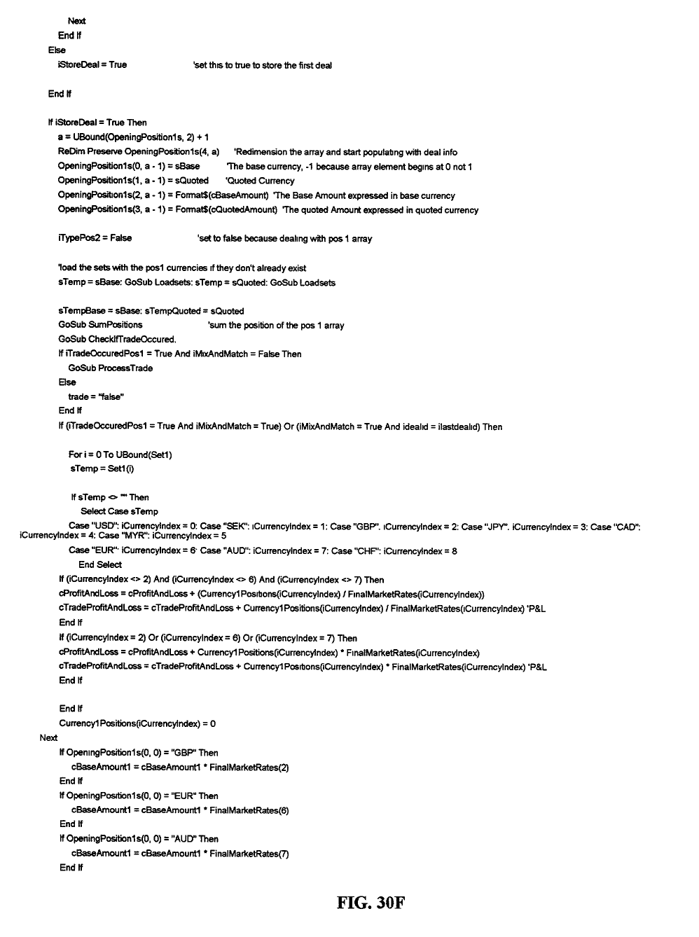

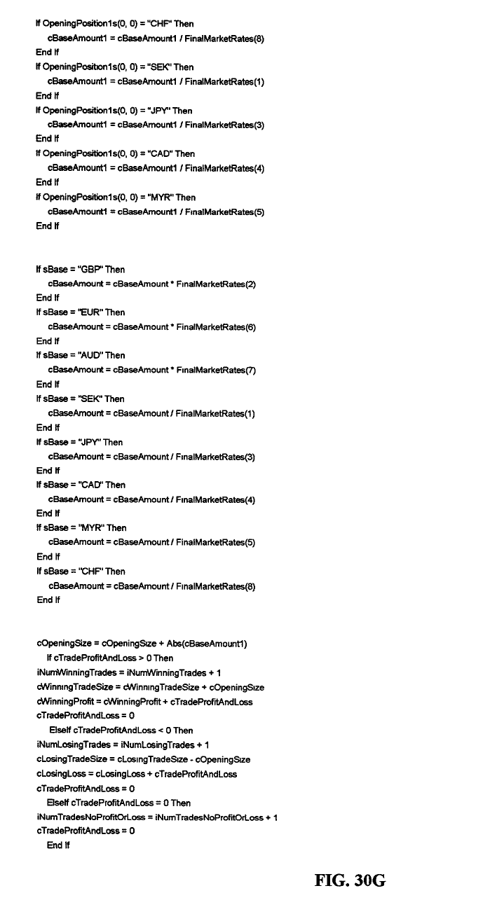

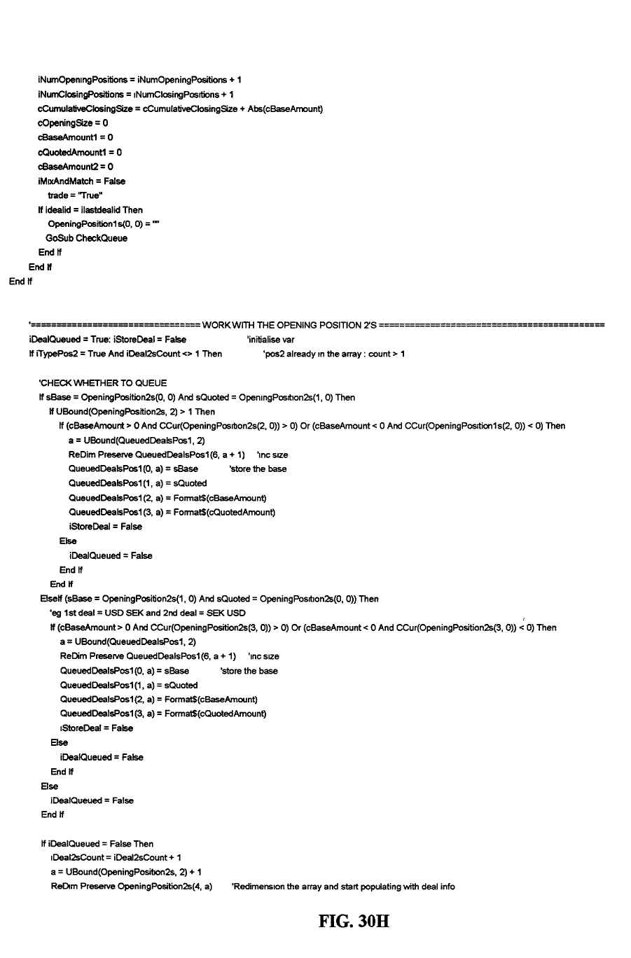

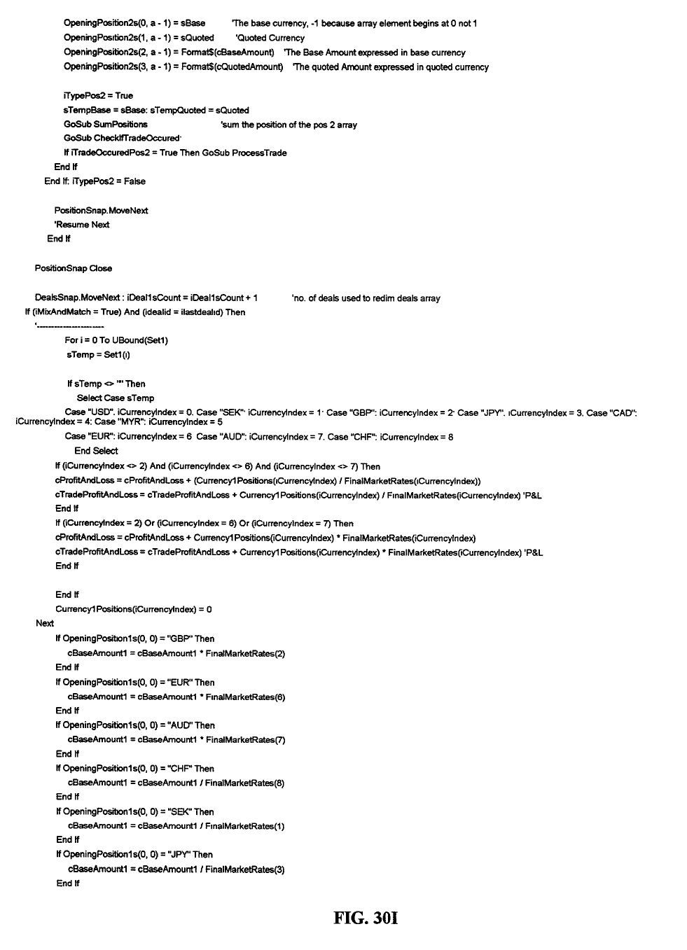

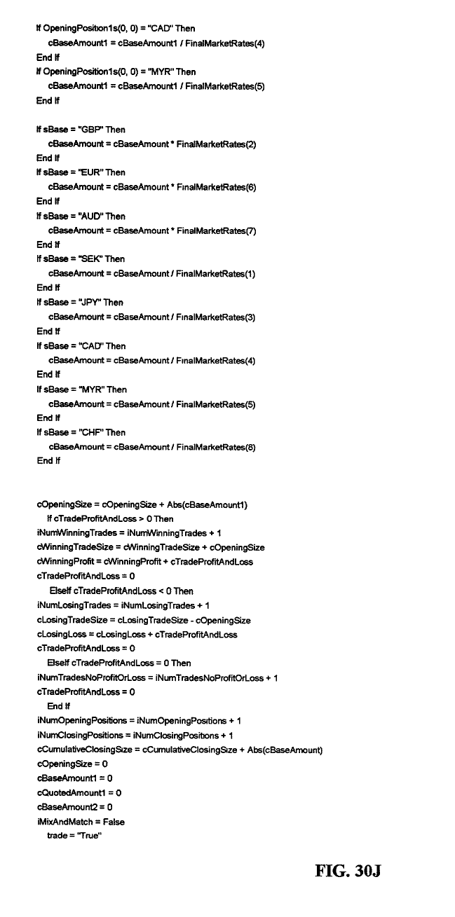

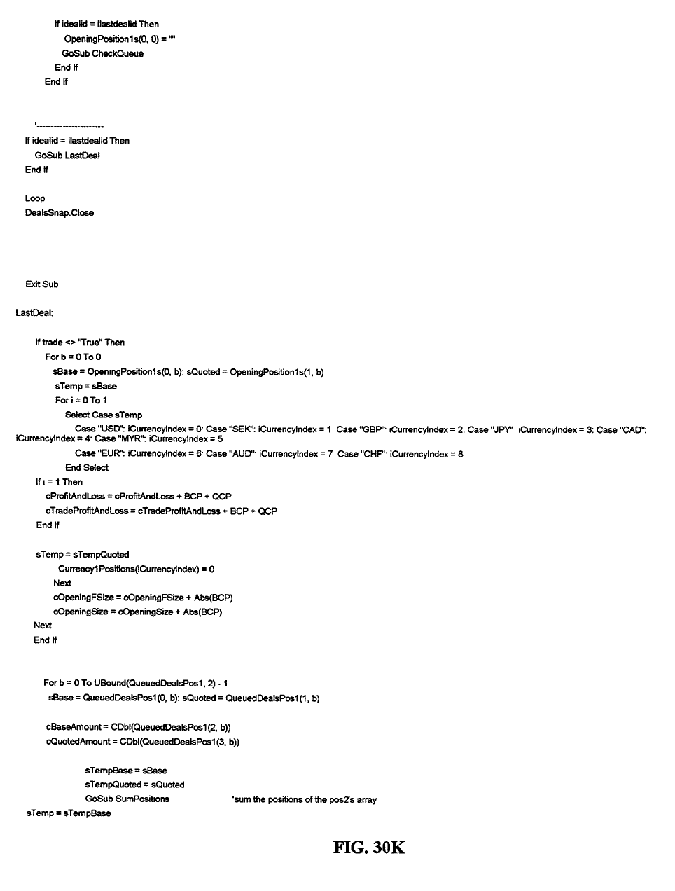

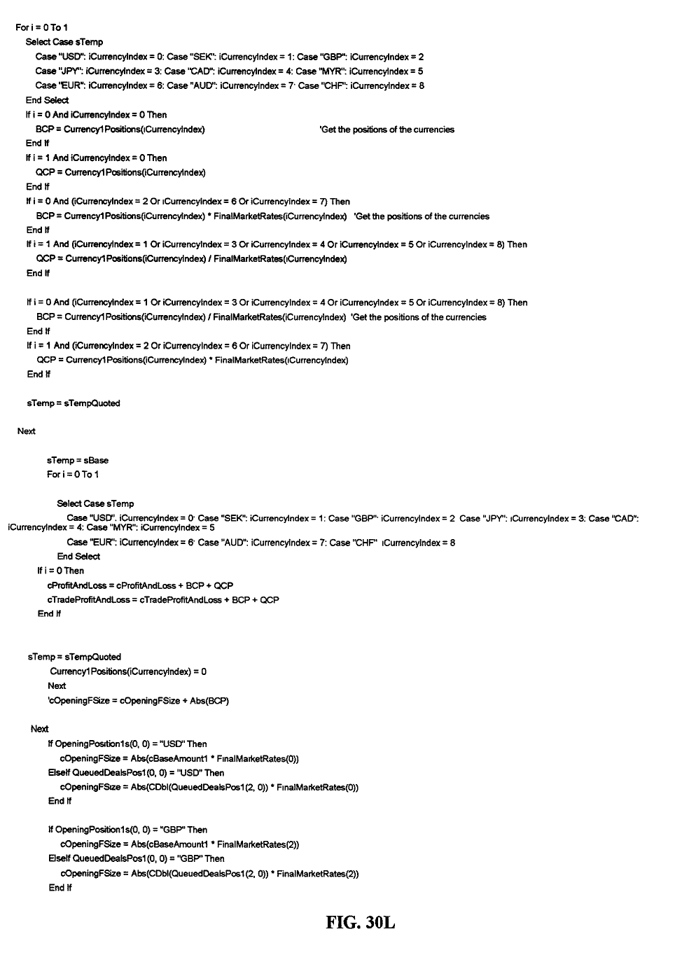

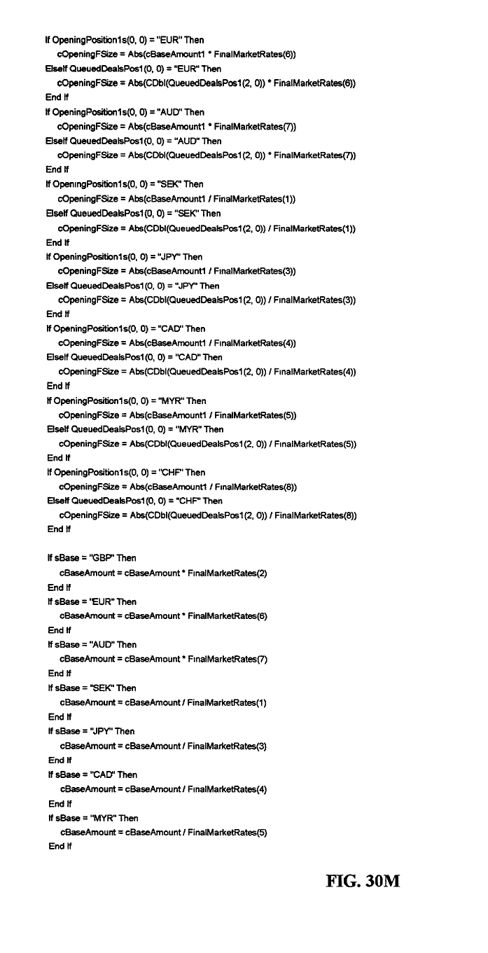

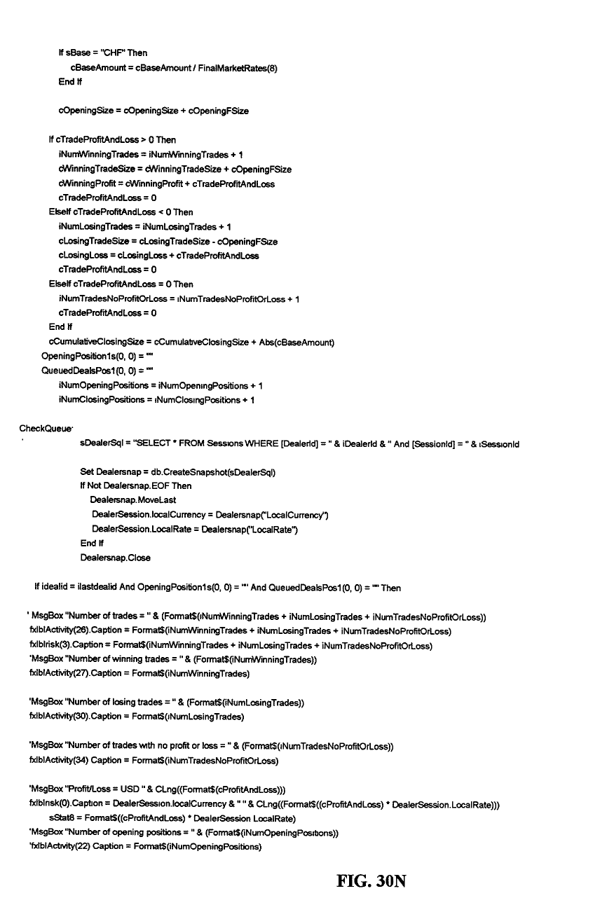

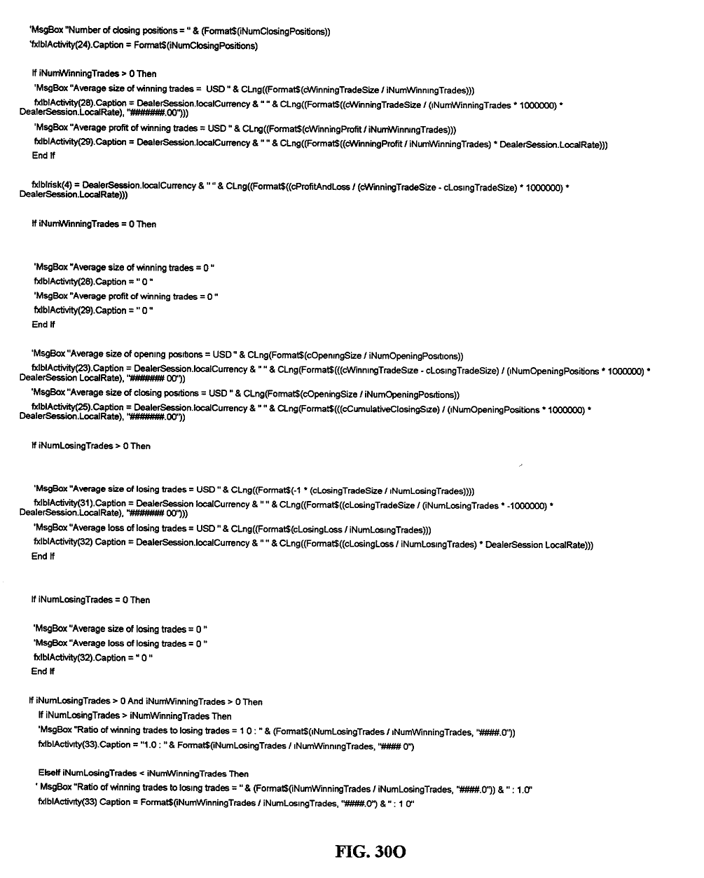

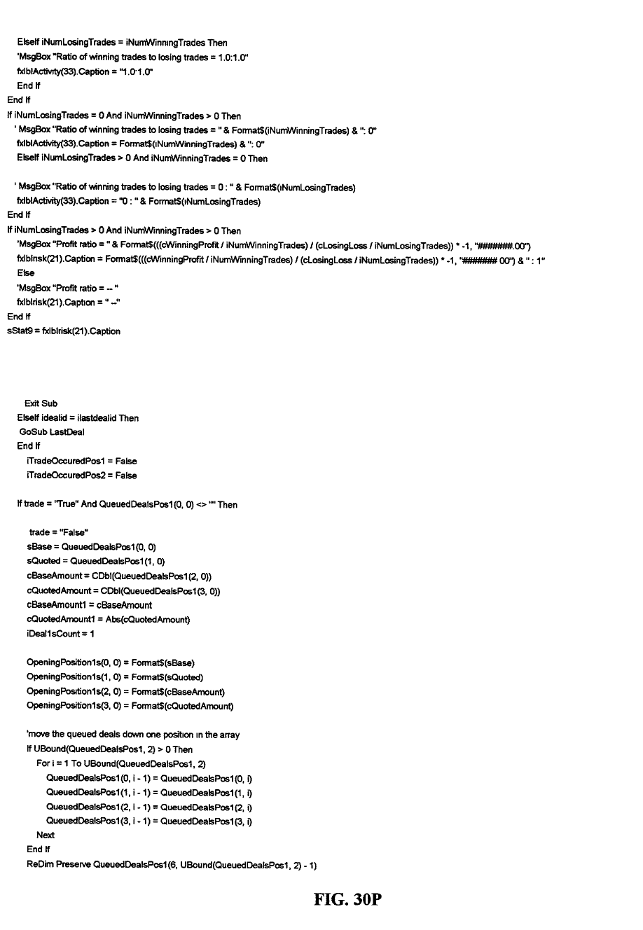

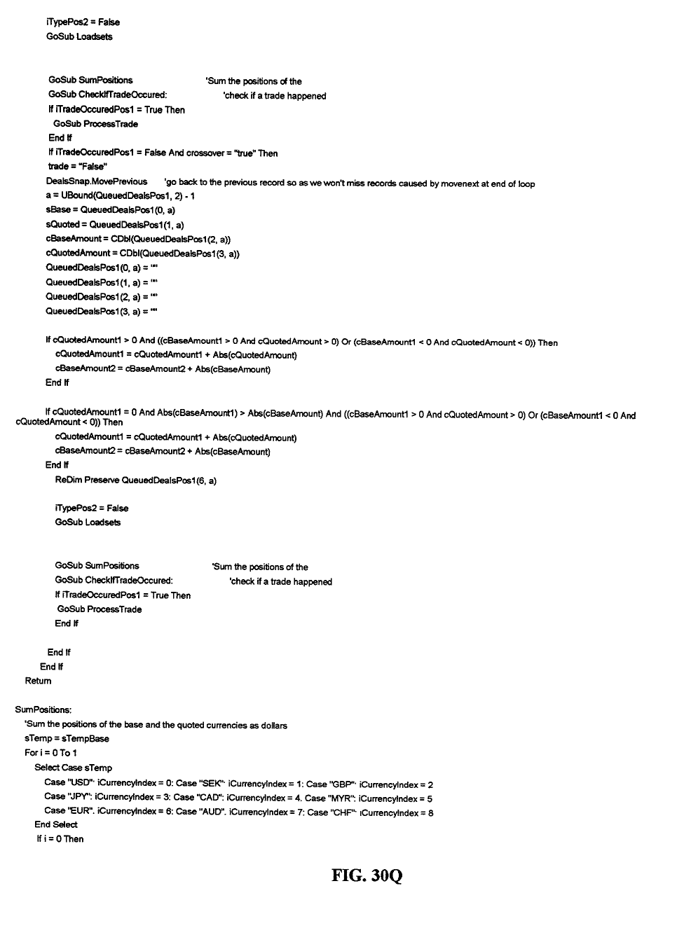

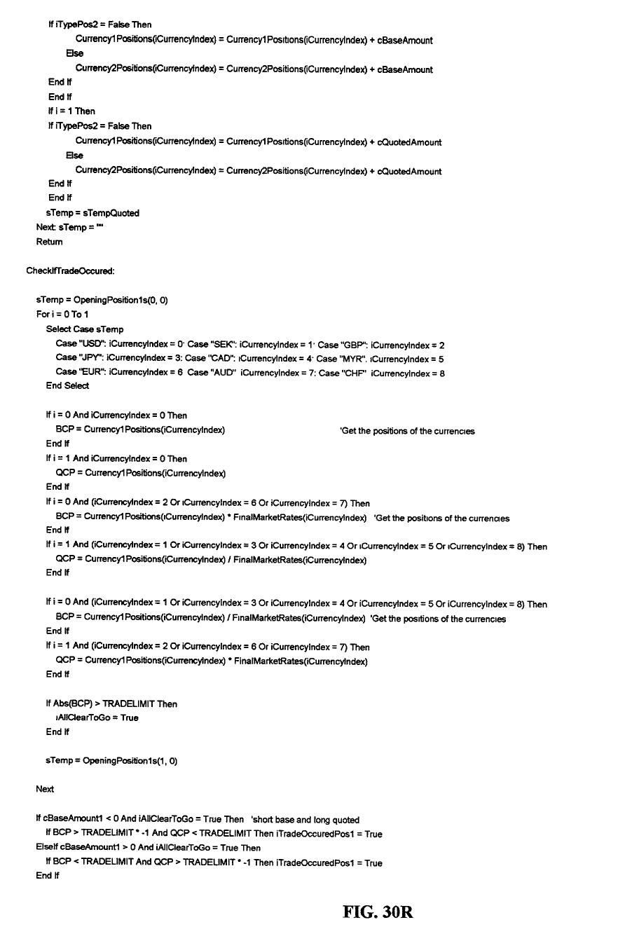

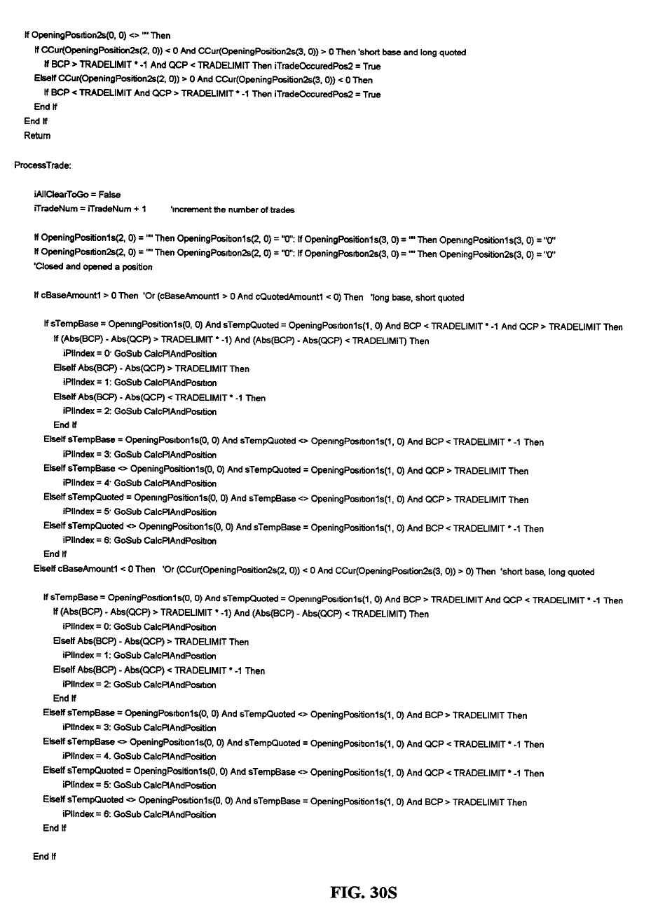

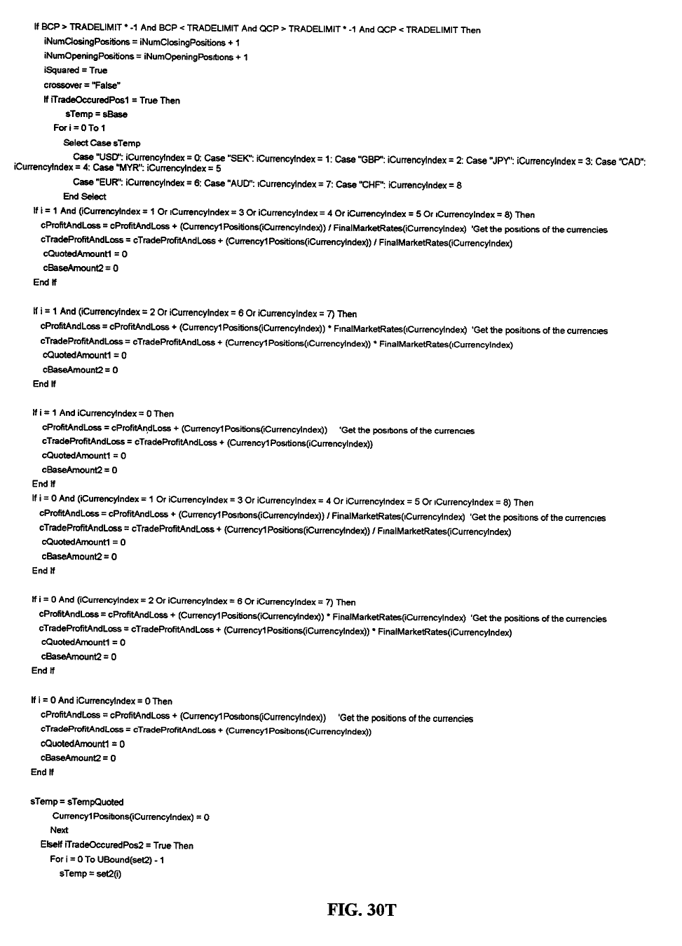

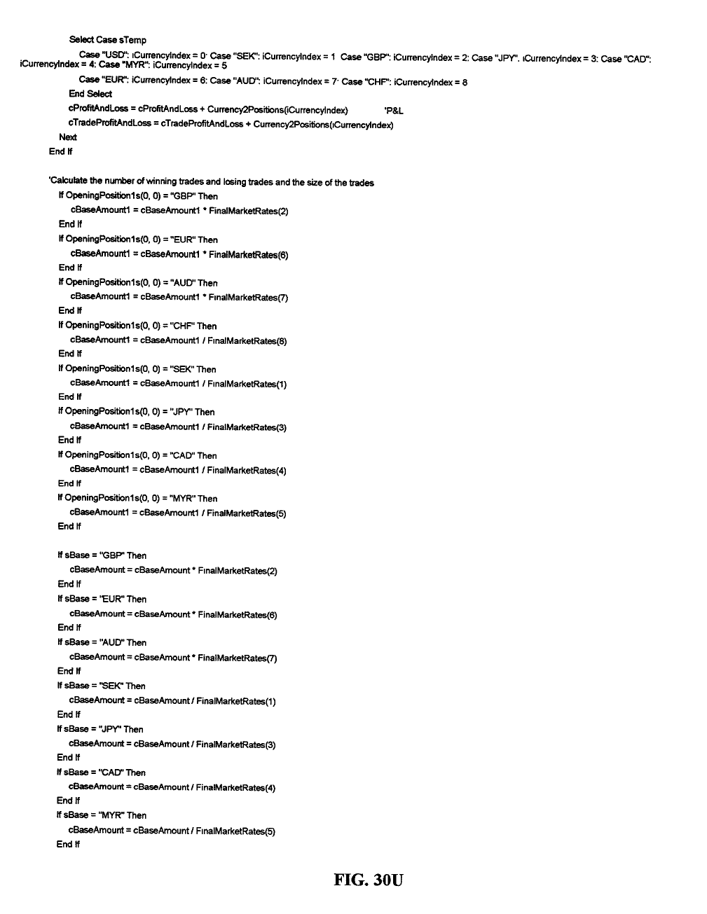

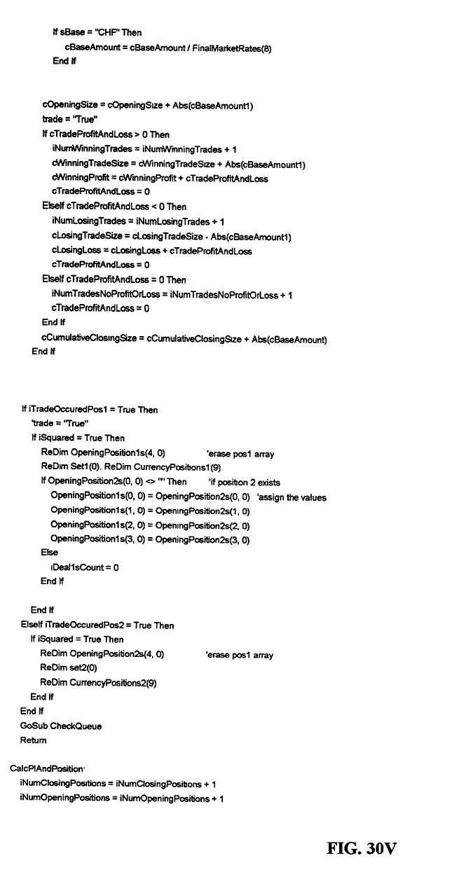

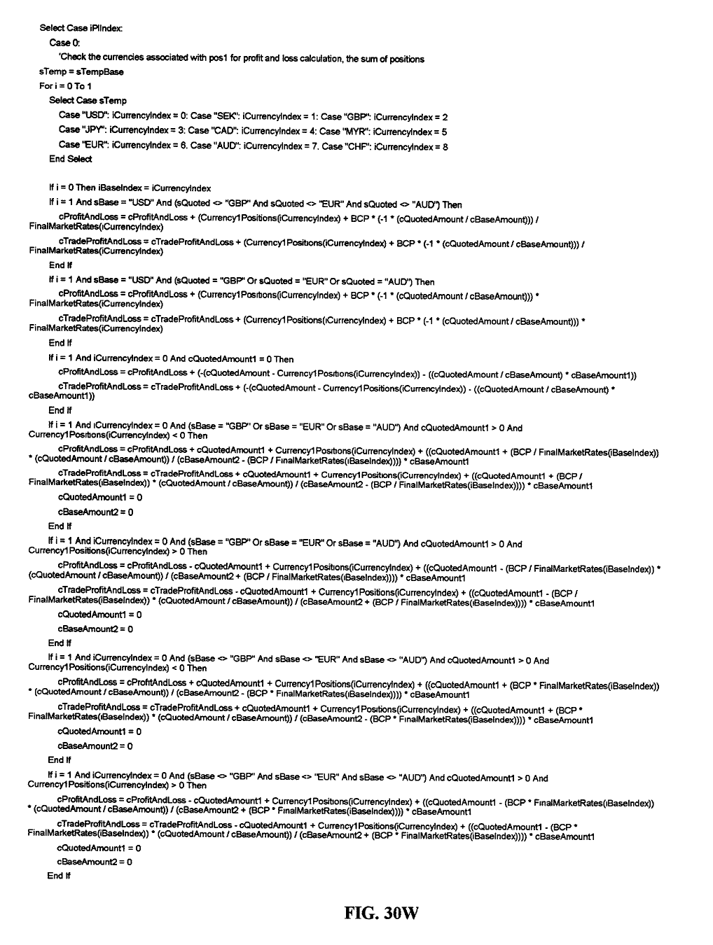

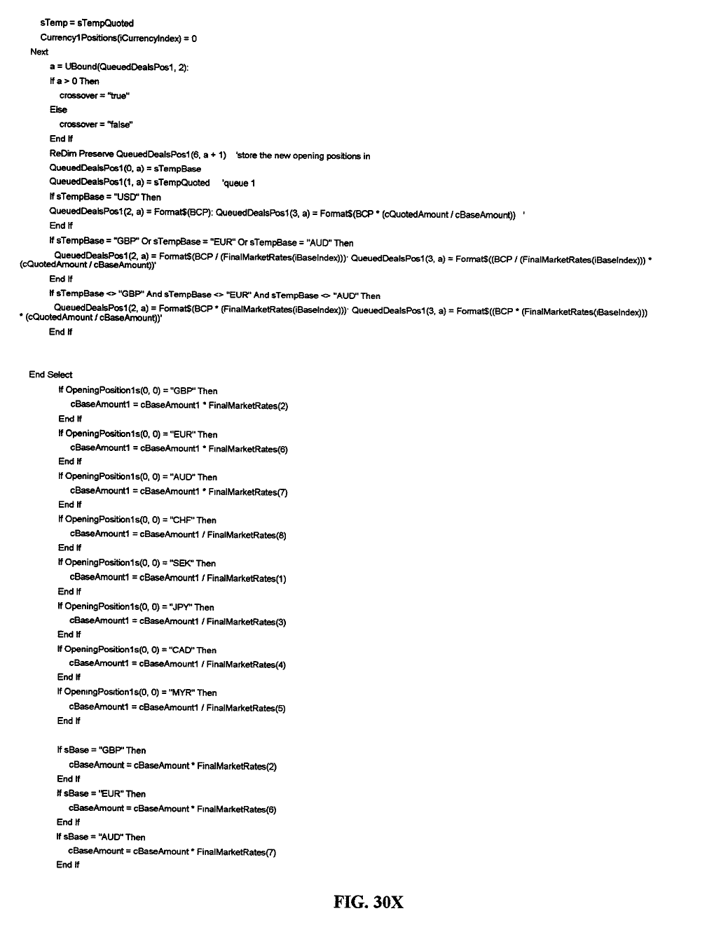

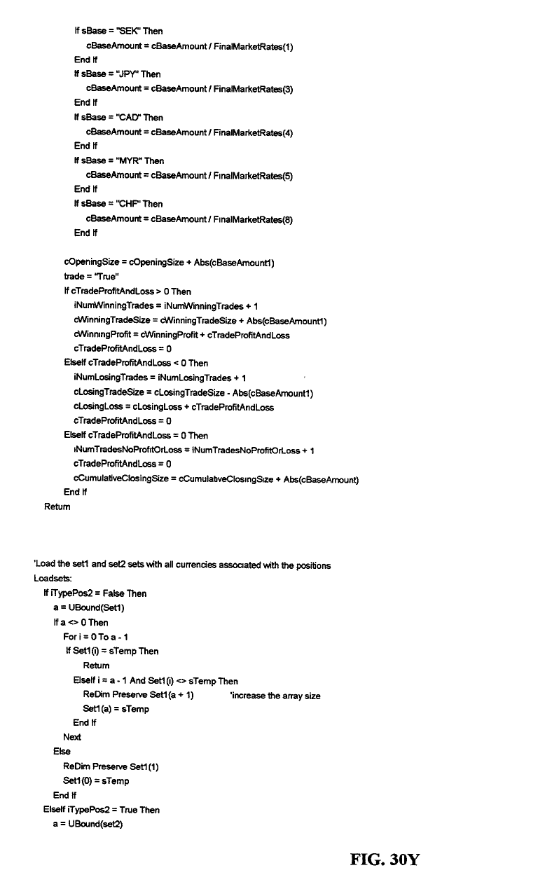

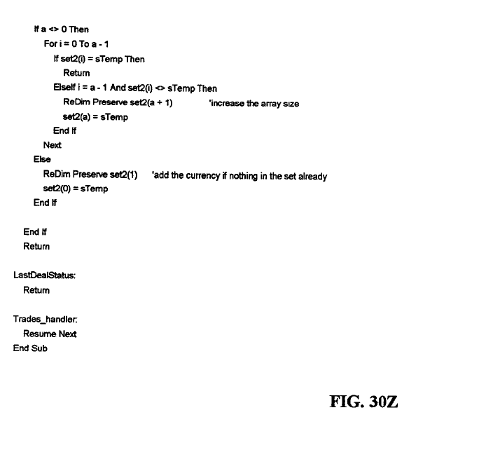

Finally, examples of reusable software modules used to drive the above-depicted “conquer mode” functionality are presented in FIGS. 27-30. In particular, FIGS. 27A-H collectively depict code used to get the positions of traders. FIGS. 28A-G collectively depict code used to create an incoming call. FIGS. 29A-FF collectively depict code used to record a deal. And 30A-Z collectively depict code used to calculate trades.

While the foregoing has described the invention by recitation of its various aspects/features and an illustrative embodiment thereof, those skilled in the art will recognize that alternative elements and techniques, and/or combinations and sub-combinations of the described and/or incorporated elements and techniques, can be substituted for, or added to, those described herein. The present invention, therefore, should not be limited to, or defined by, the specific apparatus, methods, and articles-of-manufacture described herein, but rather by the appended claims, which are intended to be construed in accordance with well-settled principles of claim construction, including, but not limited to, the following:

Limitations should not be read from the specification or drawings into the claims (e.g., if the claim calls for a “chair,” and the specification and drawings show a rocking chair, the claim term “chair” should not be limited to a rocking chair, but rather should be construed to cover any type of “chair”).

The words “comprising,” “including,” and “having” are always open-ended, irrespective of whether they appear as the primary transitional phrase of a claim, or as a transitional phrase within an element or sub-element of the claim (e.g., the claim “a widget comprising: A; B; and C” would be infringed by a device containing 2A's, B, and 3C's; also, the claim “a gizmo comprising: A; B, including X, Y, and Z; and C, having P and Q” would be infringed by a device containing 3A's, 2X's, 3Y's, Z, 6P's, and Q).

The indefinite articles “a” or “an” mean “one or more”; where, instead, a purely singular meaning is intended, a phrase such as “one,” “only one,” or “a single,” will appear.

Where the phrase “means for” precedes a data processing or manipulation “function,” it is intended that the resulting means-plus-function element be construed to cover any, and all, computer implementation(s) of the recited “function” using any standard programming techniques known by, or available to, persons skilled in the computer programming arts.

A claim that contains more than one computer-implemented means-plus-function element should not be construed to require that each means-plus-function element must be a structurally distinct entity (such as a particular piece of hardware or block of code); rather, such claim should be construed merely to require that the overall combination of hardware/firmware/software which implements the invention must, as a whole, implement at least the function(s) called for by the claims.

What is claimed is:

1. A computer-based method for training a user to perform skill-based task(s), the method comprising:
providing a learn mode, wherein a programmed computer controls the path of learning and the user controls the pace of learning, thereby enabling a novice user to gain familiarity with basic skills needed to perform the task(s);
providing a master mode, wherein the programmed computer and user both control the path of learning, and the computer and user both control the pace of learning, thereby enabling a user having familiarity with some of the skills needed to perform the task(s) to gain additional knowledge and/or confidence in applying said needed skills in performing said task(s); and,
providing a conquer mode, wherein the user controls the path of learning and the programmed computer controls the pace of learning, thereby enabling a user having familiarity with most of the skills needed to perform the task(s) to gain additional knowledge and/or confidence in applying said needed skills through real-time, free-flowing simulations of said task(s);
wherein providing said learn, master and conquer modes involves use of a plurality of replaceable software modules to provide functionality needed to support said learn, master and conquer modes.

2. A computer-based method for training a user to perform skill-based task(s) as defined in claim 1, wherein said plurality of replaceable software modules includes at least one of: (i) replaceable media file(s); (ii) replaceable interactive display module(s); and/or (iii) replaceable software calculator(s).

3. A computer-based method for training a user to perform skill-based task(s) as defined in claim l wherein said plurality of replaceable software modules includes at least two of: (i) replaceable media file(s); (ii) replaceable interactive display module(s); and/or (iii) replaceable software calculator(s).

4. A computer-based method for training a user to perform skill-based task(s) as defined in claim 1, wherein said plurality of replaceable software modules includes at least three of: (i) replaceable media file(s); (ii) replaceable interactive display module(s); and/or (iii) replaceable software calculator(s).

5. A computer-based method for training a user to perform skill-based task(s) as defined in claim 1, wherein said programmed computer operates under control of a core Macromedia Authorware program, and said plurality of replaceable software modules includes at least one of: (i) replaceable media file(s); (ii) replaceable interactive display module(s); and/or (iii) replaceable software calculator(s).

6. A computer-based method for training a user to perform skill-based task(s) as defined in claim r, wherein said programmed computer operates under control of a core Macromedia Authorware program, and said plurality of replaceable software modules includes at least two of: (i) replaceable media file(s); (ii) replaceable interactive display module(s); and/or (iii) replaceable software calculator(s).

7. A computer-based method for training a user to perform skill-based task(s) as defined in claim A, wherein said programmed computer operates under control of a core Macromedia Authorware program, and said plurality of replaceable software modules includes at least three of: (i) replaceable media file(s); (ii) replaceable interactive display module(s); and/or (iii) replaceable software calculator(s).

8. A computer-based method for training a user to perform skill-based task(s) as defined in claim 1, wherein said programmed computer operates under control of a core Macromedia Authorware program, which controls a plurality of demand-loaded modules, including at least one of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

9. A computer-based method for training a user to perform skill-based task(s) as defined in claim 1, wherein said programmed computer operates under control of a core Macromedia Authorware program, which controls a plurality of demand-loaded modules, including at least two of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

10. A computer-based method for training a user to perform skill-based task(s) as defined in claim 1, wherein said programmed computer operates under control of a core Macromedia Authorware program, which controls a plurality of demand-loaded modules, including at least three of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

11. A computer-based method for training a user to perform skill-based task(s) as defined in claim 1, wherein said programmed computer operates under control of a core Macromedia Authorware program, which controls a plurality of demand-loaded modules, including at least four of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

12. A computer-based method for training a user to perform skill-based task(s) as defined in claim 1, wherein said programmed computer operates under control of a core Macromedia Authorware program, which controls a plurality of demand-loaded modules, including at least five of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

13. A computer-based method for training a user to perform skill-based task(s) as defined in claim 1, wherein said programmed computer operates under control of a core Macromedia Authorware program, which controls a plurality of demand-loaded modules, including at least six of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

14. A computer-based method for training a user to perform skill-based task(s) as defined in claim 1, wherein said programmed computer operates under control of a core Macromedia Authorware program, which controls a plurality of demand-loaded modules, including at least seven of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

15. A computer-based method for training a user to perform skill-based task(s) as defined in claim 1, wherein said programmed computer operates under control of a core Macromedia Authorware program, which controls a plurality of demand-loaded modules, including at least eight of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

16. A computer-based method for training a user to perform skill-based task(s) as defined in claim 1, wherein said programmed computer operates under control of a core Macromedia Authorware program, which controls a plurality of demand-loaded modules, including at least nine of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

17. A computer-based method for training user(s) for financial trading desk operations, the method comprising:
providing an interactive display that includes at least two of:
a tabular display that includes, at least, price data for a plurality of financial products;
at least one inbound telephone line icon for receiving simulated client calls;
one or more outbound telephone line icons for placing simulated outbound calls;
at least one calculator icon for permitting user(s) to perform financial calculations; and/or,
a help icon for providing hints and/or explanations to user(s)
by selectively loading and executing a plurality of replaceable software modules, including at least two of: (i) replaceable media file(s); (ii) replaceable interactive display module(s); and/or (iii) replaceable software calculator(s).

18. A computer-based method for training user(s) for financial trading desk operations, the method comprising:
providing an interactive display that includes at least three of:
a tabular display that includes, at least, price data for a plurality of financial products;
at least one inbound telephone line icon for receiving simulated client calls;
one or more outbound telephone line icons for placing simulated outbound calls;
at least one calculator icon for permitting user(s) to perform financial calculations; and/or,
a help icon for providing hints and/or explanations to user(s)
by selectively loading and executing a plurality of replaceable software modules, including at least two of: (i) replaceable media file(s); (ii) replaceable interactive display module(s); and/or (iii) replaceable software calculator(s).

19. A computer-based method for training user(s) for financial trading desk operations, the method comprising:
providing an interactive display that includes at least four of:
a tabular display that includes, at least, price data for a plurality of financial products;
at least one inbound telephone line icon for receiving simulated client calls;
one or more outbound telephone line icons for placing simulated outbound calls;
at least one calculator icon for permitting user(s) to perform financial calculations; and/or,
a help icon for providing hints and/or explanations to user(s)
by selectively loading and executing a plurality of replaceable software modules, including at least two of: (i) replaceable media file(s); (ii) replaceable interactive display module(s); and/or (iii) replaceable software calculator(s).

20. A method for training student(s) for financial trading occupations, the method comprising:
using a programmed computer workstation to guide said student(s) through a multiphase learning process, including:
providing a computer-driven learn mode in which novice student(s) can gain familiarity with basic financial trading concepts and/or skills;
providing a computer-driven master mode in which student(s) begin to test the skills acquired in the learn mode by engaging in guided scenario simulations that require student(s) to effectively apply selected skill(s); and,
providing a conquer mode in which student(s) refine and test their mastery of learned skill(s) by engaging in realistic, free-flowing simulations and test their ability to meet predetermined objective(s) by reviewing detailed post-simulation performance reports, including at least one of:
a detailed report of the student's trading positions throughout the simulation;
a detailed report of the student's ability to remain within trading limits during the simulation;
a detailed report of risk(s) associated with the student's trading activity during the simulation;
a detailed report of the student's trading activity during the simulation, including at least the number of calls serviced and the number winning/losing trades;
a detailed report of the accuracy of price quotes given by the student during the simulation;
a detailed report of the timeliness of the student's responses during the simulation;
a detailed analysis the student's willingness to anticipate trades during the simulation; and/or,
a summary report of the student's overall performance during the simulation;
wherein at least the conquer mode is provided by selectively loading and executing replaceable software module(s), including at least two of: (i) replaceable media file(s); (ii) replaceable interactive display module(s); and/or (iii) replaceable software calculator(s).

21. A method for training student(s) for financial trading occupations, the method comprising:
using a programmed computer workstation to guide said student(s) through a multiphase learning process, including:
providing a computer-driven learn mode in which novice student(s) can gain familiarity with basic financial trading concepts and/or skills;
providing a computer-driven master mode in which student(s) begin to test the skills acquired in the learn mode by engaging in guided scenario simulations that require student(s) to effectively apply selected skill(s); and,
providing a conquer mode in which student(s) refine and test their mastery of learned skill(s) by engaging in realistic, free-flowing simulations and test their ability to meet predetermined objective(s) by reviewing detailed post-simulation performance reports, including at least two of:
a detailed report of the student's trading positions throughout the simulation;
a detailed report of the student's ability to remain within trading limits during the simulation;
a detailed report of risk(s) associated with the student's trading activity during the simulation;
a detailed report of the student's trading activity during the simulation, including at least the number of calls serviced and the number winning/losing trades;
a detailed report of the accuracy of price quotes given by the student during the simulation;
a detailed report of the timeliness of the student's responses during the simulation;
a detailed analysis the student's willingness to anticipate trades during the simulation; and/or,
a summary report of the student's overall performance during the simulation;
wherein at least the conquer mode is provided by selectively loading and executing replaceable software module(s), including at least two of: (i) replaceable media file(s); (ii) replaceable interactive display module(s); and/or (iii) replaceable software calculator(s).

22. A method for training student(s) for financial trading occupations, the method comprising:
using a programmed computer workstation to guide said student(s) through a multiphase learning process, including:
providing a computer-driven learn mode in which novice student(s) can gain familiarity with basic financial trading concepts and/or skills;
providing a computer-driven master mode in which student(s) begin to test the skills acquired in the learn mode by engaging in guided scenario simulations that require student(s) to effectively apply selected skill(s); and,
providing a conquer mode in which student(s) refine and test their mastery of learned skill(s) by engaging in realistic, free-flowing simulations and test their ability to meet predetermined objective(s) by reviewing detailed post-simulation performance reports, including at least three of:
a detailed report of the student's trading positions throughout the simulation;
a detailed report of the student's ability to remain within trading limits during the simulation;
a detailed report of risk(s) associated with the student's trading activity during the simulation;
a detailed report of the student's trading activity during the simulation, including at least the number of calls serviced and the number winning/losing trades;
a detailed report of the accuracy of price quotes given by the student during the simulation;
a detailed report of the timeliness of the student's responses during the simulation;
a detailed analysis the student's willingness to anticipate trades during the simulation; and/or,
a summary report of the student's overall performance during the simulation;
wherein at least the conquer mode is provided by selectively loading and executing replaceable software module(s), including at least two of: (i) replaceable media file(s); (ii) replaceable interactive display module(s); and/or (iii) replaceable software calculator(s).

23. A method for training student(s) for financial trading occupations, the method comprising:
using a programmed computer workstation to guide said student(s) through a multiphase learning process, including:
providing a computer-driven learn mode in which novice student(s) can gain familiarity with basic financial trading concepts and/or skills;
providing a computer-driven master mode in which student(s) begin to test the skills acquired in the learn mode by engaging in guided scenario simulations that require student(s) to effectively apply selected skill(s); and,
providing a conquer mode in which student(s) refine and test their mastery of learned skill(s) by engaging in realistic, free-flowing simulations and test their ability to meet predetermined objective(s) by reviewing detailed post-simulation performance reports, including at least four of:
a detailed report of the student's trading positions throughout the simulation;
a detailed report of the student's ability to remain within trading limits during the simulation;
a detailed report of risk(s) associated with the student's trading activity during the simulation;
a detailed report of the student's trading activity during the simulation, including at least the number of calls serviced and the number winning/losing trades;
a detailed report of the accuracy of price quotes given by the student during the simulation;
a detailed report of the timeliness of the student's responses during the simulation;
a detailed analysis the student's willingness to anticipate trades during the simulation; and/or,
a summary report of the student's overall performance during the simulation;
wherein at least the conquer mode is provided by selectively loading and executing replaceable software module(s), including at least two of: (i) replaceable media file(s); (ii) replaceable interactive display module(s); and/or (iii) replaceable software calculator(s).

24. A computer-based system, including a programmed computer configured for training a user to perform skill-based task(s), the system comprising:
a learn mode engine which controls the user's path of learning and permits the user to control the pace of learning, thereby enabling a novice user to learn basic skills needed to perform the task(s);
a master mode engine which controls in part, and permits the user to control in part, both the path of learning and the pace of learning, thereby enabling a user having familiarity with some of the skills needed to perform the task(s) to gain additional knowledge and/or confidence in applying said needed skills in performing said task(s); and,
a conquer mode engine which controls the pace of learning, and permits the user to control the path of learning, thereby enabling a user having familiarity with most of the skills needed to perform the task(s) to gain additional knowledge and/or confidence in applying said needed skills through real-time, free-flowing simulations of said task(s);
wherein at least one of said learn mode engine, master mode engine and/or conquer mode engine comprises a plurality of replaceable software modules.

25. A computer-based system, as defined in claim 24, wherein said plurality of replaceable software modules includes at least one of: (i) replaceable media file(s); (ii) replaceable interactive display module(s); and/or (iii) replaceable software calculator(s).

26. A computer-based system, as defined in claim 24, wherein said plurality of replaceable software modules includes at least two of: (i) replaceable media file(s); (ii) replaceable interactive display module(s); and/or (iii) replaceable software calculator(s).

27. A computer-based system, as defined in claim 24, wherein said plurality of replaceable software modules includes at least: (i) replaceable media file(s); (ii) replaceable interactive display module(s); and (iii) replaceable software calculator(s).

28. A computer-based system, as defined in claim 24, further comprising a core Macromedia Authorware program, which controls loading and/or execution of said plurality of replaceable software modules.

29. A computer-based system, as defined in claim 24, further comprising a core Macromedia Authorware program, which controls a plurality of demand-loaded modules, including at least one of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

30. A computer-based system, as defined in claim 24, further comprising a core Macromedia Authorware program, which controls a plurality of demand-loaded modules, including at least three of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

31. A computer-based system, as defined in claim 24, further comprising a core Macromedia Authorware program, which controls a plurality of demand-loaded modules, including at least five of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

32. A computer-based system, as defined in claim 24, comprising a core Macromedia Authorware program, which controls a plurality of demand-loaded modules, including at least seven of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

33. A computer-based system for training user(s) for financial trading desk operations, the system comprising:
an interactive display that includes at least two of:
a tabular display that includes, at least, price data for a plurality of financial products;
at least one inbound telephone line icon for receiving simulated client calls;
one or more outbound telephone line icons for placing simulated outbound calls;
at least one calculator icon for permitting user(s) to perform financial calculations; and/or,
a help icon for providing hints and/or explanations to user(s); and,
a core Macromedia Authorware program that controls loading and/or execution of a plurality of replaceable software modules, including at least two of: (i) replaceable media file(s); (ii) replaceable interactive display module(s); and/or (iii) replaceable software calculator(s).

34. A computer-based system for training user(s) for financial trading desk operations, the system comprising:
an interactive display that includes at least four of:
a tabular display that includes, at least, price data for a plurality of financial products;
at least one inbound telephone line icon for receiving simulated client calls;
one or more outbound telephone line icons for placing simulated outbound calls;
at least one calculator icon for permitting user(s) to perform financial calculations; and/or,
a help icon for providing hints and/or explanations to user(s); and,
a core Macromedia Authorware program that controls loading and/or execution of a plurality of replaceable software modules, including at least three of: (i) replaceable media file(s); (ii) replaceable interactive display module(s); and/or (iii) replaceable software calculator(s).

35. A system for training student(s) for financial trading occupations, the system comprising:
a computer workstation programmed to guide said student(s) through a multiphase learning process, including:
a learn mode, in which novice student(s) can gain familiarity with basic financial trading concepts and/or skills;
a master mode, in which student(s) begin to test the skills acquired in the learn mode by engaging in guided scenario simulations that require student(s) to effectively apply selected skill(s); and,
a conquer mode, in which student(s) refine and test their mastery of learned skill(s) by engaging in realistic, free-flowing simulations and test their ability to meet predetermined objective(s) by reviewing detailed post-simulation performance reports, including at least three of:
a detailed report of the student's trading positions throughout the simulation;
a detailed report of the student's ability to remain within trading limits during the simulation;
a detailed report of risk(s) associated with the student's trading activity during the simulation;
a detailed report of the student's trading activity during the simulation, including at least the number of calls serviced and the number winning/losing trades;
a detailed report of the accuracy of price quotes given by the student during the simulation;
a detailed report of the timeliness of the student's responses during the simulation;
a detailed analysis the student's willingness to anticipate trades during the simulation; and/or,
a summary report of the student's overall performance during the simulation;
said programmed workstation including code which, in at least the conquer mode, controls loading and execution of a plurality of replaceable software module(s), including at least two of: (i) replaceable media file(s); (ii) replaceable interactive display module(s); and/or (iii) replaceable software calculator(s).

36. A computer-readable medium for use in connection with a computer-based training system, said computer-readable medium including a plurality of instructions which, when executed, cause a computer to provide at least two distinct modes of computer-based learning functionality, said computer-readable medium further including a plurality of demand-loaded modules, including at least three of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.

37. A computer-readable medium for use in connection with a computer-based training system, said computer-readable medium including a plurality of instructions which, when executed, cause a computer to provide at least two distinct modes of computer-based learning functionality, said computer-readable medium further including a plurality of demand-loaded modules, including at least five of: (i) a simulation control module that provides the logic flow for running interactive task simulations; (ii) a question-and-answer module that permits database-driven testing of user(s); (iii) a table module that permits interactive display, scrolling and highlighting of tables; (iv) an explanation zone module that provides database-driven and tracked web-page browsing of explanations; (v) a calculator module that permits user(s) to perform complex calculations; (vi) a download module that manages downloading of files for use by the programmed computer and uploading of user-tracking data to a central database; (vii) sound files used to generate speech; (viii) table files used to provide text for display in tables; (ix) graphics files used to generate pictures; (x) web pages used to provide explanations; and (xi) flash movie files used to provide animated explanations.
